(19) United States
(12) Patent Application Publication
(10) Pub. No.: US 2024/0239528 A1
(43) Pub. Date: Jul. 18, 2024

(54) HIGH THREAT RESPONSE SYSTEM

(71) Applicant: Brecourt Solutions Inc., Gurnee, IL (US)

(72) Inventors: David J. Forman, Gurnee, IL (US); Jeffrey Grant Ross; Jensen Stahr, Gurnee, IL (US); Brad Allen, Libertyville, IL (US); Nathaniel Jesgarz, Petosky, MI (US); Kevin Kain; Erick JOHNSON; Ryan Jarvis, Windsor, CT (US)

(21) Appl. No.: 18/411,670

(22) Filed: Jan. 12, 2024

Related U.S. Application Data
(60) Provisional application No. 63/438,950, filed on Jan. 13, 2023.

(51) Int. Cl. B64U 30/29; B64U 101/15; F41H 11/00

(52) U.S. Cl. CPC B64U 30/29; F41H 11/00; B64U 2101/15; B64U 2201/10; B64U 2201/20

(57) ABSTRACT

A drone and method for responding to a high-threat target. The drone may be used to strike a firearm or weapon in the possession of a high-threat target or the drone may comprise one or more firearm malfunction devices attached to the drone, wherein the drone deploys the device to disable or prevent the high-threat target from accessing the firearm or weapon and/or distract a high-threat target.

### RELATED APPLICATIONS AND INCORPORATION BY REFERENCE

This application claims benefit of and priority to U.S. Provisional Patent Application Ser. No. 63/438,950, filed Jan. 13, 2023. The foregoing application is hereby incorporated by reference.

### FIELD OF DISCLOSURE

The present invention relates to a drone system and method which engages high threat targets.

### BACKGROUND

Mass shootings are becoming more prevalent in public areas such as schools, hospitals, government buildings, and large venues. The typical response to active shooter situations is to deploy law enforcement officers to the scene of a shooting. Alternatively, some have advocated for teachers and civilian employees to be armed with guns to engage in counterfire to protect themselves and other innocent bystanders until the arrival of law enforcement. However, when civilians are not trained properly in firearms, this could result in innocent bystanders getting seriously injured.

Waiting for law enforcement to arrive at the scene and assess the situation before engaging with an active shooter takes time. In life-threatening situations, every second counts.

As an attempt to address the need for a fast solution, unmanned autonomous vehicles (UAV or UAVs) were created to assist responders by detecting criminal activity and reducing the lethality of active shooters by increasing the responders' situational awareness. Current UAV systems deployed by law enforcement and security companies generally capture video feed and obtain information through sensors. In other systems, UAVs have been proposed to interfere with suspects utilizing a passive means such as lights and sound or a nonlethal active means, such as a taser.

Alternatively, some UAVs may deploy lethal methods to neutralize a threat. However, such methods pose ethical dilemmas. As such, there exists a need for a device that collects information and actively neutralizes a weapon in control of a high-threat target. The present disclosure provides for a UAV-based target system that identifies a potential high-threat target, provides information to responders and activates autonomous and/or remote-controlled UAVs equipped with devices that target the inanimate weapon (instead of the high-threat individual) and cause a malfunction in the weapon.

### SUMMARY OF DISCLOSURE

The present disclosure relates to a UAV-based system utilizing engineering principles and devices that may be used to engage a weapon during a high-threat event. The devices are intended to interrupt normal operations of a firearm, therefore causing a malfunction. These devices provide law enforcement the appropriate nonlethal autonomous and/or remote controlled attachments to intercept the weapon system and render the weapon inoperable, thus effectively disabling the threat.

### BRIEF DESCRIPTION OF DRAWINGS

FIG. 1 depicts a perspective view of a drone and bistable band attachment.

FIG. 2 depicts a second perspective view of the drone and attachment of FIG. 1.

FIG. 3 depicts a front view of the drone and attachment of FIG. 1.

FIG. 4 depicts a rear view of the drone and attachment of FIG. 1.

FIG. 5 depicts a side view of the drone and attachment of FIG. 1.

FIG. 6 depicts a second side view of the drone and attachment of FIG. 1.

FIG. 7 depicts a top view of the drone and attachment of FIG. 1.

FIG. 8 depicts a bottom view of the drone and attachment of FIG. 1.

FIG. 9 depicts a perspective view of the drone with a claw attachment.

FIG. 10 depicts a second perspective view of the drone with a claw attachment.

FIG. 11 depicts a front view of the drone and claw attachment of FIG. 9.

FIG. 12 depicts a side view of the drone and claw attachment of FIG. 9.

FIG. 13 depicts a perspective view of the drone and harpoon attachment.

FIG. 14 depicts a second perspective view of the drone and harpoon attachment of FIG. 13.

FIG. 15 depicts a front view of the drone and harpoon attachment of FIG. 13.

FIG. 16 depicts a side view of the drone and harpoon attachment of FIG. 13.

FIG. 17 depicts a perspective view of the drone and a second claw attachment.

FIG. 18 depicts a second perspective view of the drone and claw attachment of FIG. 17.

FIG. 19 depicts a front view of the drone and claw attachment of FIG. 17.

FIG. 20 depicts a side view of the drone and claw attachment of FIG. 17.

FIG. 21 depicts a perspective view of a drone and inflatable bag attachment.

FIG. 22 depicts a rear view of the drone and inflatable bag attachment of FIG. 21.

FIG. 23 depicts a side view of the drone and inflatable bag attachment of FIG. 22.

FIG. 24 depicts a perspective view of a second embodiment of the drone and inflatable bag attachment.

FIG. 25 depicts a front view of the drone and inflatable bag attachment of FIG. 24.

FIG. 26 depicts a side view of the drone and inflatable bag attachment of FIG. 25.

FIG. 27 depicts a perspective view of a drone and net attachment.

FIG. 28 depicts a front view of the drone and net attachment of FIG. 27.

FIG. 29 depicts a side view of the drone and net attachment of FIG. 27.

FIG. 30 depicts an assembly of drones and attachments operating as a unit.

FIG. 31 depicts a bottom perspective view of the electromagnetic drone.

FIG. 32 depicts a side view of the electromagnetic drone of FIG. 31.

FIG. 33 depicts a side view of the electromagnetic drone of FIG. 31.

FIG. 34 depicts a bottom view of the electromagnetic drone of FIG. 31.

FIG. 35 depicts a top view of the electromagnetic drone of FIG. 31.

FIG. 36 depicts a perspective view of a bistable band.

FIG. 37 depicts a front view of the bistable band in FIG. 36.

FIG. 38 depicts a side view of the bistable band in FIG. 36.

FIG. 39 depicts a perspective view of a foldable drone.

FIG. 40 depicts a front view of the foldable drone of FIG. 39.

FIG. 41 depicts a side view of the foldable drone of FIG. 39.

FIG. 42 depicts a top view of the foldable drone of FIG. 39.

FIG. 43 depicts a perspective view of the foldable drone in a partially folded position.

FIG. 44 depicts an exploded view of a firearm malfunction UAV.

FIG. 45 depicts a perspective view of propeller guard sub-assembly of the firearm malfunction UAV of FIG. 44.

FIG. 46 depicts a perspective view of the motors, propellers, and other modules of the firearm malfunction UAV of FIG. 44.

FIG. 47 depicts a perspective view of the central frame of the firearm malfunction UAV of FIG. 44.

FIG. 48 depicts a perspective view of the internal components of firearm malfunction UAV of FIG. 44.

FIG. 49 depicts a perspective view of the top frame of the firearm malfunction UAV of FIG. 44.

FIG. 50 depicts a perspective view of the battery pack system of the firearm malfunction UAV of FIG. 44.

FIG. 51 depicts a perspective view of the assembled firearm malfunction UAV of FIG. 44.

FIG. 52 depicts a top perspective view of the assembled firearm malfunction UAV of FIG. 44.

FIG. 53 depicts a front view of the assembled firearm malfunction UAV of FIG. 44.

FIG. 54 depicts a rear view of the assembled firearm malfunction UAV of FIG. 44.

FIG. 55 depicts a top view of the assembled firearm malfunction UAV of FIG. 44.

FIG. 56 depicts a side view of the assembled firearm malfunction UAV of FIG. 44.

FIG. 57 depicts an exploded view of a drone housing assembly and the assembled firearm malfunction UAV.

FIG. 58 depicts a perspective view of the bottom housing of the drone housing assembly of FIG. 57.

FIG. 59 depicts a perspective view of the top housing of the drone housing assembly of FIG. 57.

FIG. 60 depicts a perspective view of the battery cover of the drone housing assembly of FIG. 57.

FIG. 61 depicts a second perspective view of the top housing of the drone housing assembly of FIG. 57.

FIG. 62 depicts a rear perspective view of the top housing of the drone housing assembly of FIG. 57.

FIG. 63 depicts a front view of the top housing of the drone housing assembly of FIG. 57.

FIG. 64 depicts a rear view of the top housing of the drone housing assembly of FIG. 57.

FIG. 65 depicts a top view of the top housing of the drone housing assembly of FIG. 57.

FIG. 66 depicts a bottom view of the top housing of the drone housing assembly of FIG. 57.

FIG. 67 depicts a bottom perspective view of the top housing of the drone housing assembly of FIG. 57.

FIG. 68 depicts a perspective view of the assembled firearm malfunction UAV within the assembled drone housing assembly.

FIG. 69 depicts a side view of the assembled firearm malfunction UAV within the assembled drone housing assembly of FIG. 68.

FIG. 70 depicts a side cutaway view of the assembled firearm malfunction UAV within the assembled drone housing assembly of FIG. 68.

FIG. 71 depicts a malfunctioning plate attached to the front of a firearm malfunction UAV.

FIG. 72 depicts a second embodiment of a malfunctioning plate attached to the front of a firearm malfunction UAV.

FIG. 73 depicts a third embodiment of a malfunctioning plate attached to the front of a firearm malfunction UAV.

FIG. 74 depicts a fourth embodiment of a malfunctioning plate attached to the front of a firearm malfunction UAV.

FIG. 75 depicts a front view of a fifth embodiment of a malfunctioning plate attached to the front of a firearm malfunction UAV.

FIG. 76 depicts a side view of the malfunctioning plate attached to the front of a firearm malfunction UAV of FIG. 75.

FIG. 77 depicts a rear perspective view of the malfunctioning plate attached to the front of a firearm malfunction UAV of FIG. 75.

FIG. 78 depicts a front view of a sixth embodiment of a malfunctioning plate integral with a firearm malfunction UAV.

FIG. 79 depicts a side view of the malfunctioning plate attached to the front of a firearm malfunction UAV of FIG. 78.

FIG. 80 depicts a side view of an airbag actuator device.

FIG. 81 depicts a second side view of the airbag actuator device of FIG. 80.

FIG. 82 depicts a front-side perspective view of the airbag actuator device of FIG. 80.

FIG. 83 depicts a rear-side perspective view of the airbag actuator device of FIG. 80.

FIG. 84 depicts a malfunction plate loaded with magnets.

FIG. 85 depicts a malfunction plate attached to a firearm malfunction UAV approaching a firearm.

FIG. 86 depicts a firearm with magnets engaged with the firearm.

FIG. 87 depicts a firearm disabled by the magnets released from the malfunction plate.

FIG. 88 depicts an airbag actuator device approaching a firearm.

FIG. 89 depicts an airbag actuator device engaging the firearm.

FIG. 90 depicts an embodiment of the firearm malfunction UAV with both a malfunction plate and an airbag actuator device attached.

FIG. 91 depicts a carbon fiber mounting plate.

FIG. 92 depicts a diagram of airflow through the drone housing and firearm malfunction UAV when the firearm malfunction UAV is in operation.

FIG. 93 depicts a diagram of the method of using a firearm malfunction UAV.

### DETAILED DESCRIPTION

For the purposes of promoting and understanding the principles disclosed herein, reference is now made to the preferred embodiments illustrated in the drawings, and specific language is used to describe the same. It is nevertheless understood that no limitation of the scope of the invention is hereby intended. Such alterations and further modifications in the illustrated devices and such further applications of the principles disclosed and illustrated herein are contemplated as would normally occur to one of ordinary skill in the art to which this disclosure relates.

The drone system of the present disclosure comprises a drone 100 and at least one of a series of firearm malfunction devices.

### Drone

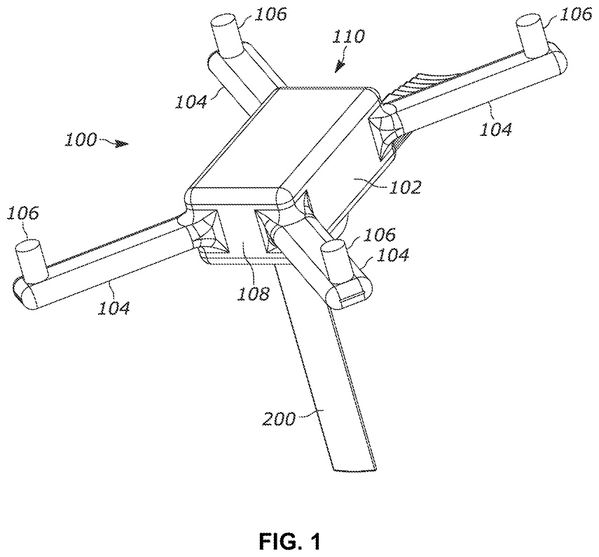

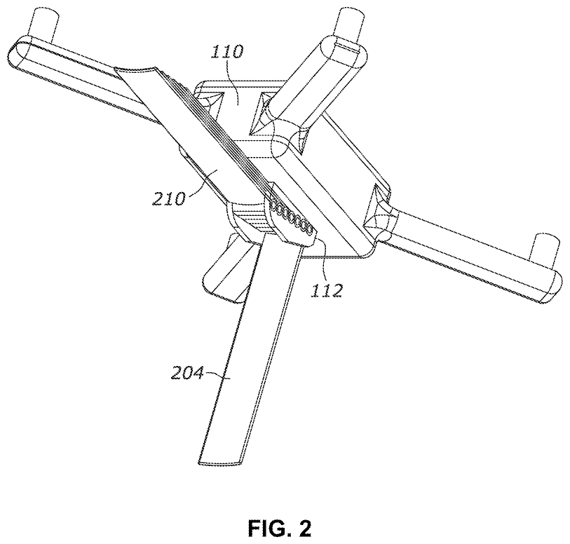

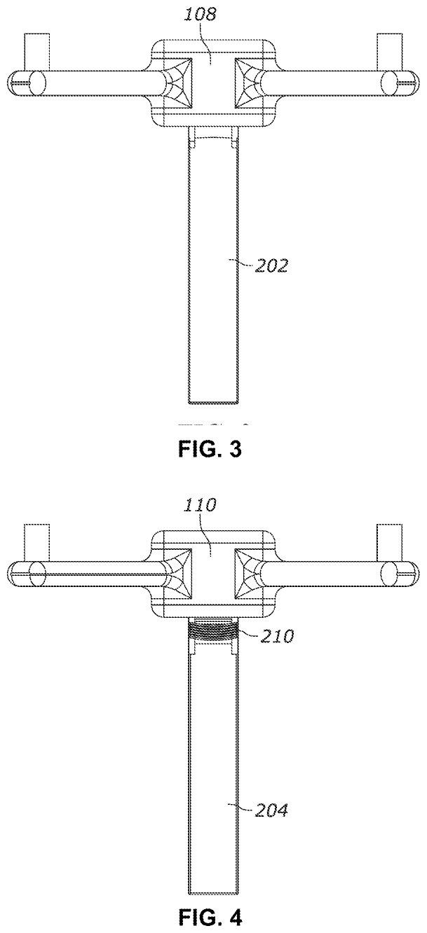

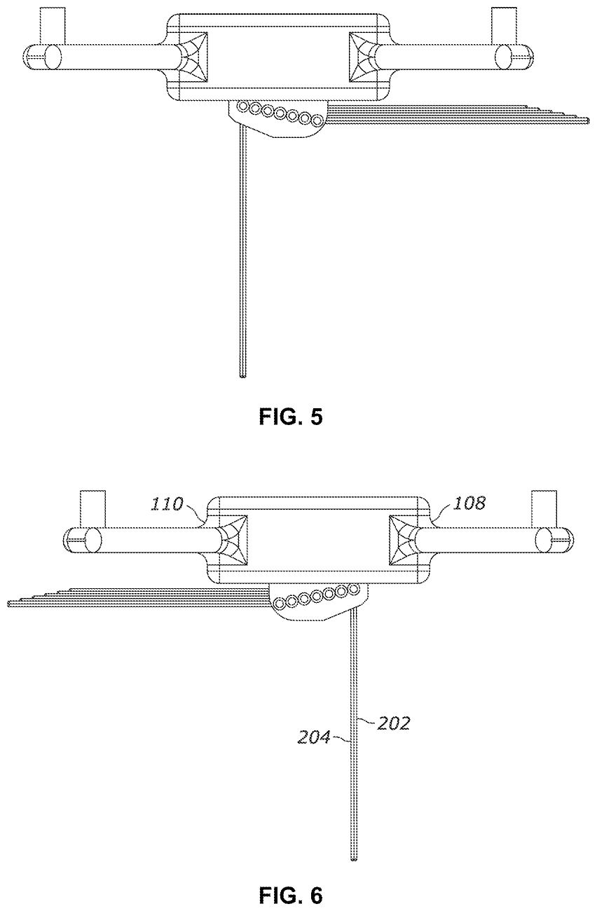

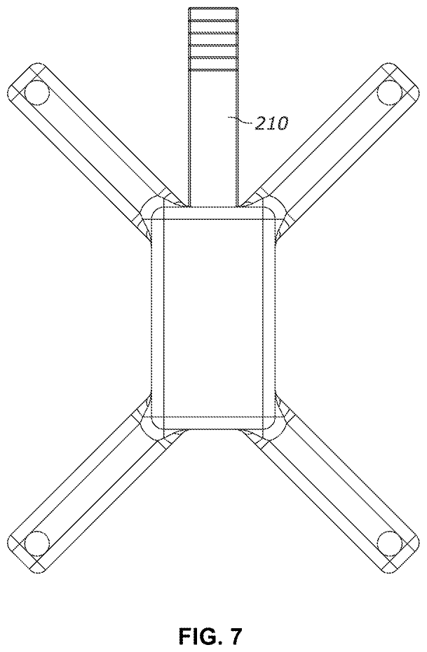

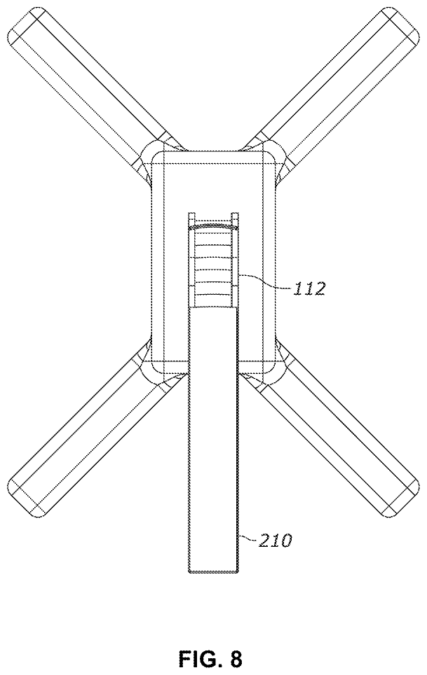

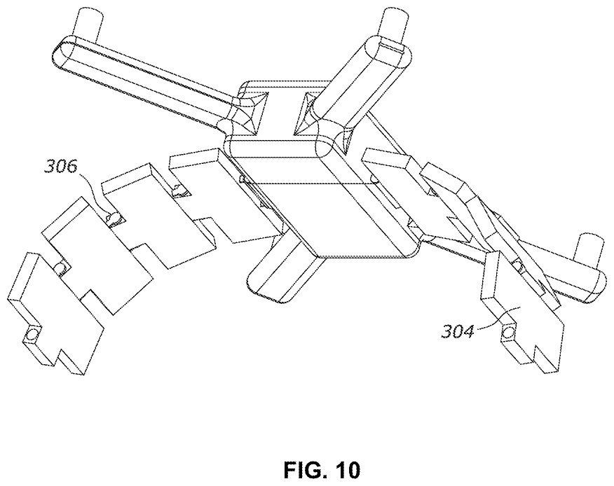

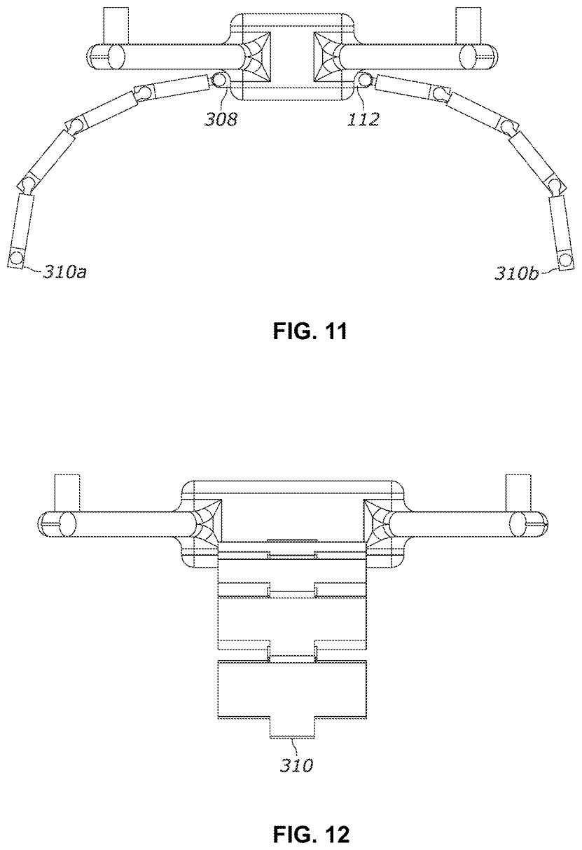

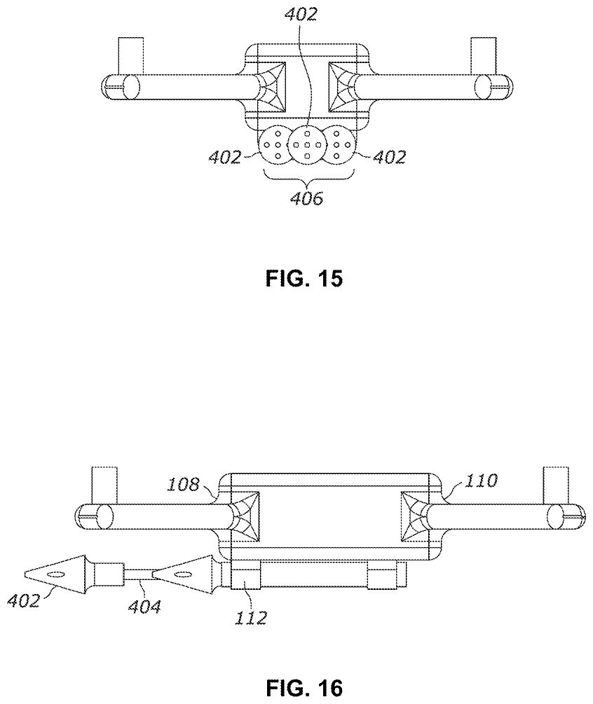

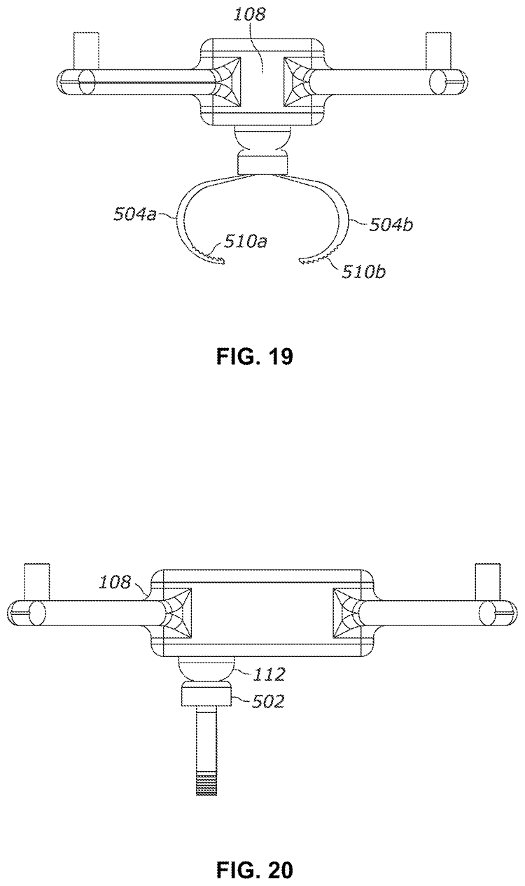

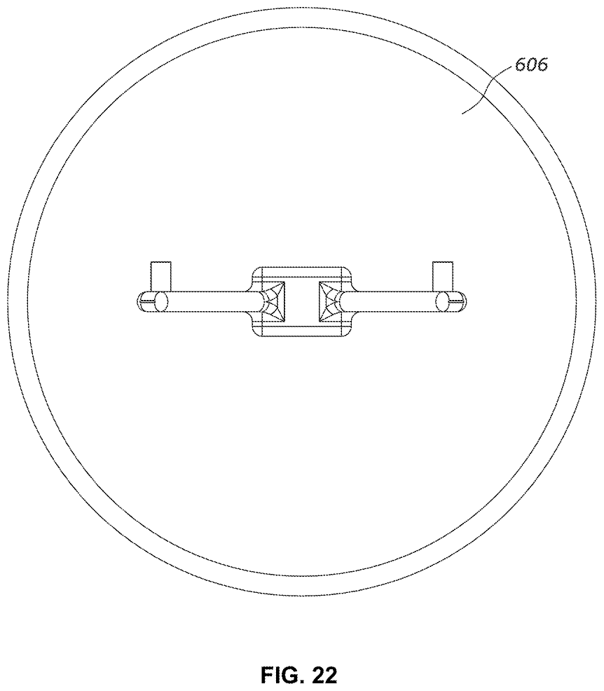

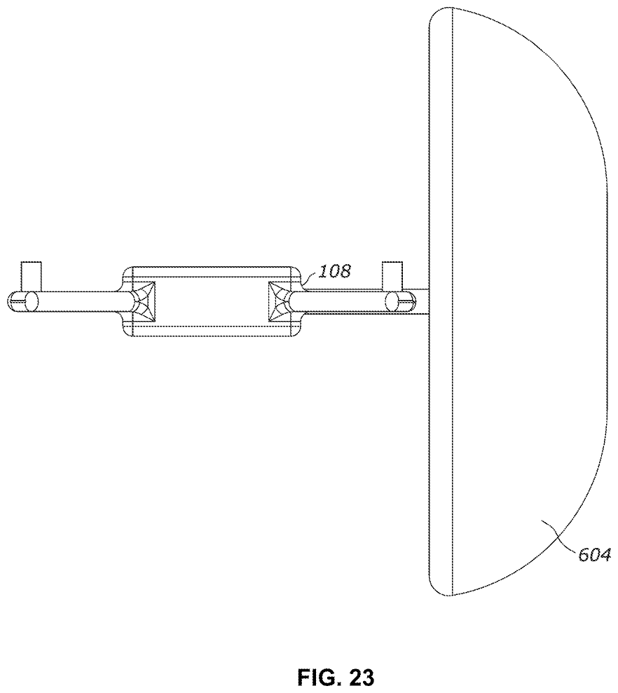

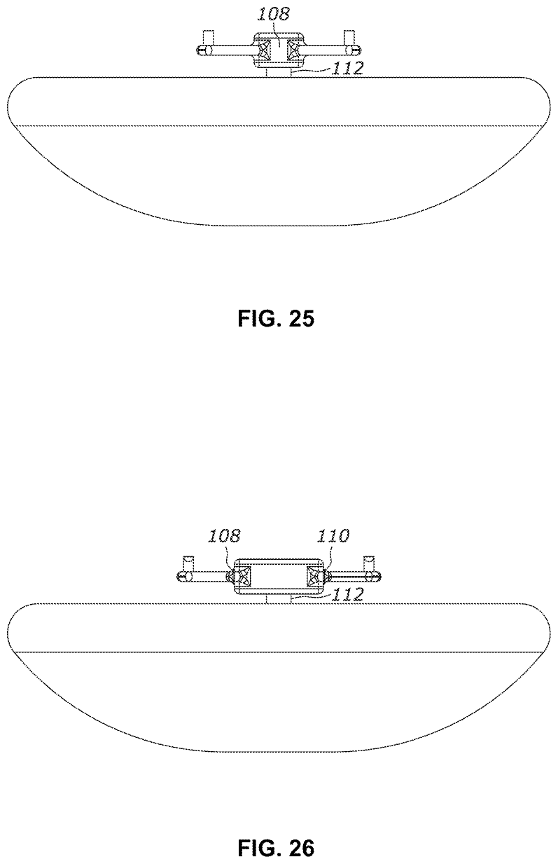

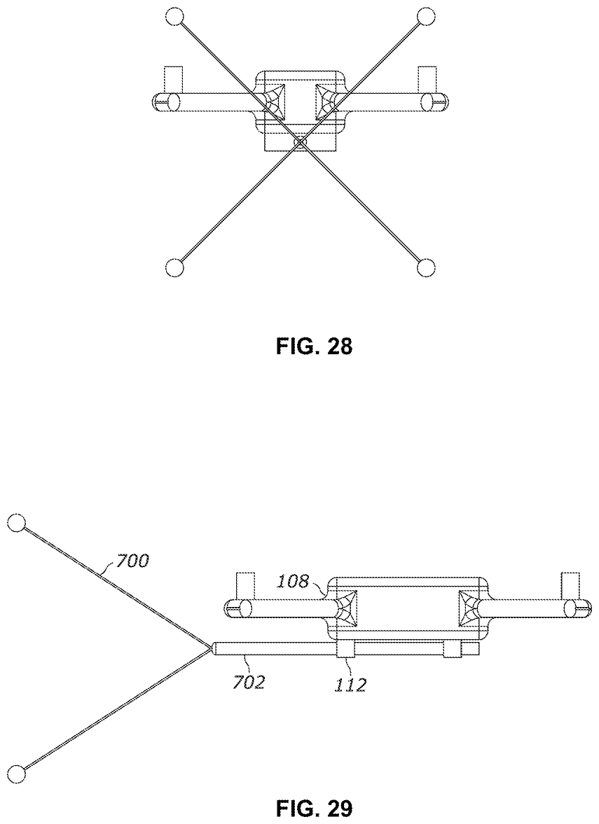

FIGS. 1-30 include depictions of a drone 100 for use in neutralizing high-threat targets. The drone 100 comprises a body 102 and at least one arm 104, wherein the at least one arm 104 comprises at least one rotor 106 and its associated rotor blade (not pictured).

The body 102 comprises a top surface, a bottom surface and a wall extending therebetween. In a preferred embodiment, the body 102 is generally in the shape of a rectangular prism and comprises a front side 108 and a back side 110.

In an embodiment, the drone 100 comprises an attachment means 112 to detachably connect to a set of firearm malfunction devices.

The drone 100 may be controlled by a user or may act autonomously to neutralize threats. In a preferred embodiment, the drone 100 is approximately 9″×9″ and has a lift capacity of between one-half to one pound.

In alternative embodiments, the configuration of the drone 100 may comprise any number of embodiments known in the art.

### Firearm Malfunction Devices

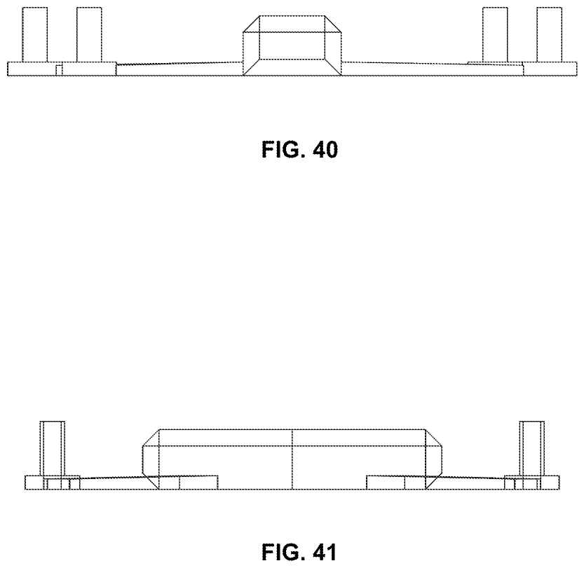

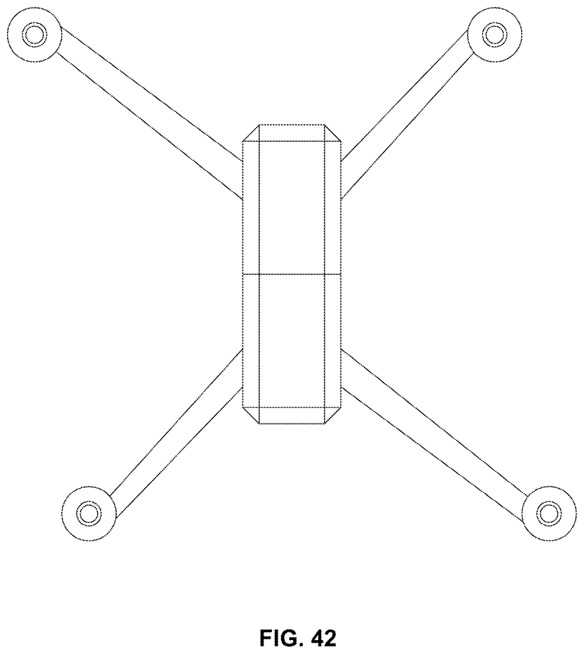

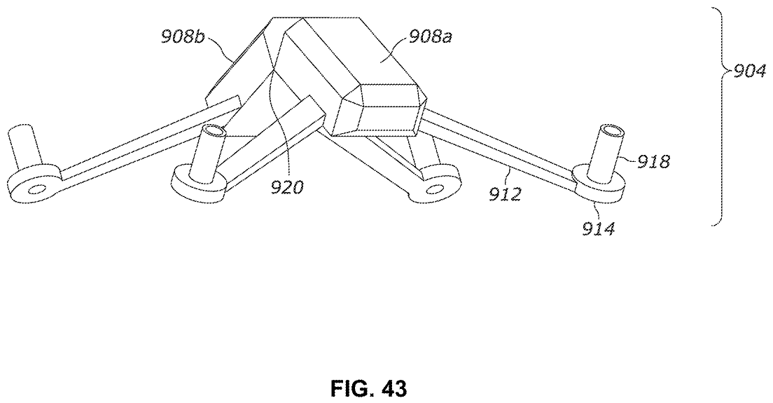

As shown in FIGS. 1-30 and 41-43, the drone 100 detachably connects to any one of a series of firearm malfunction devices. The firearm malfunction devices are described below and provide a means to neutralize high-threat targets.

### Bistable Structure (Band)

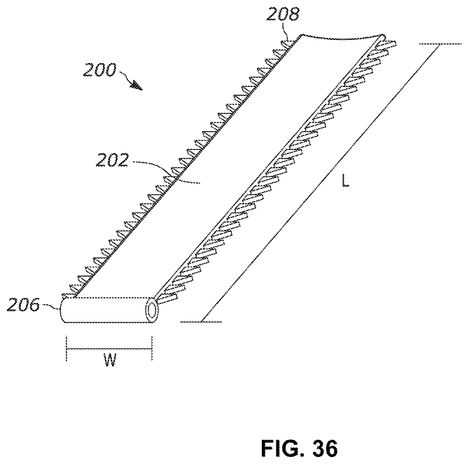

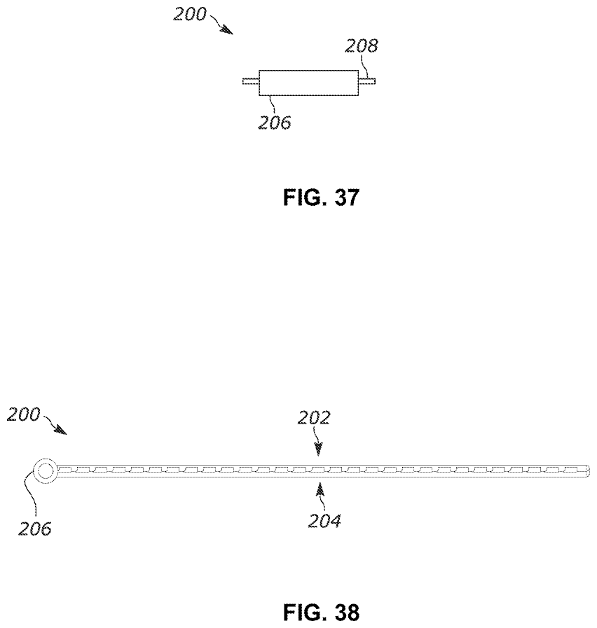

FIGS. 1-8 and 36-38 illustrate a bistable band 200. The bistable band 200 comprises a length (l), width (w), and thickness (t) and is comprised from metal, rubber, semi-plastics, plastics, or the like. The bistable band 200 comprises a front 202 and back 204 surface and is configured to wrap around and disable a weapon.

Along one end of the bistable band 200 is an attachment means 206 which allows for the bistable band 200 to attach to a drone 100. In the configuration shown in FIGS. 1-8, a plurality of bands 210 are attached to the drone 100 in a horizontal position, with the ends of the plurality of bands pointed toward the back side 110 of the drone 100. The plurality of bands 210 are connected to the drone 100 via attachment means 112, 206. Upon deployment of a first band 200, one of the plurality of bands 210 is moved into a loaded position beneath the drone. In alternate embodiments the band(s) 200 may be attached to any surface of the drone.

In an embodiment, the sides of the bistable band 200 are comprised of a series of ridges 206. The ridges 206 serve as a means to interlock with another band if desired by the user.

The bistable band 200 is capable of alternating between a loaded and coiled position. In the loaded position, the bistable band 200 is hanging from the drone 100 in a generally vertical direction and is extended to its longest length. In the coiled position, the bistable band 200 is curved throughout the length of the bistable band 200 and forms a coiled shape wherein at least a portion of the front 202 and back 204 surfaces of the bistable band 200 are in direct contact.

Upon the application of sufficient force, the bistable band 200 moves from the loaded position into the coiled position. In the coiled position, the bistable band 200 forms a diameter approximately the diameter of the object within the coil.

In an embodiment, the drone 100 applies the bistable band 200 to a firearm once the band 200 makes contact with the firearm. Once the bistable band 200 makes contact with the firearm, the bistable band 200 detaches from the drone and moves from the loaded position into the coiled position, wrapping itself around the firearm (preferably, blocking the ejection port of the firearm).

In an alternate embodiment, the bistable band 200 is launched as a projectile from the drone 100 and wraps/coils around the ejection port of a weapon.

The bistable band 200 wraps around the frame of the weapon and obscures the ejection port in order to prevent spent brass, cartridges, casings or shells from ejecting after being fired, preventing further rounds from feeding into the chamber, causing a malfunction and effectively disabling the weapon.

In an embodiment of the bistable band 200, an adhesive is applied to the front surface 202. In an additional embodiment, the bistable band 200 may comprise magnets to improve the sealing capability of the bistable band 200. In an embodiment, the bistable band 200 may apply an adhesive and/or magnets to the ejection port of the target firearm and disable the firearm. In this embodiment, even if the bistable band 200 is removed from the firearm, the adhesive and/or magnets remain in place on or in the ejection port of the target firearm and the weapon is disabled.

In a further embodiment, a first bistable band 200 may be connected to one or more additional bistable bands 200. As a representative example, two bistable bands 200 may be joined in a crisscross pattern (with the bistable bands 200 overlapping at their respective midpoints) and may engage the firearm in said crisscross pattern. Additional bistable bands 200 can be joined together to create additional configurations.

### Inflatable Device (Airbag Device)

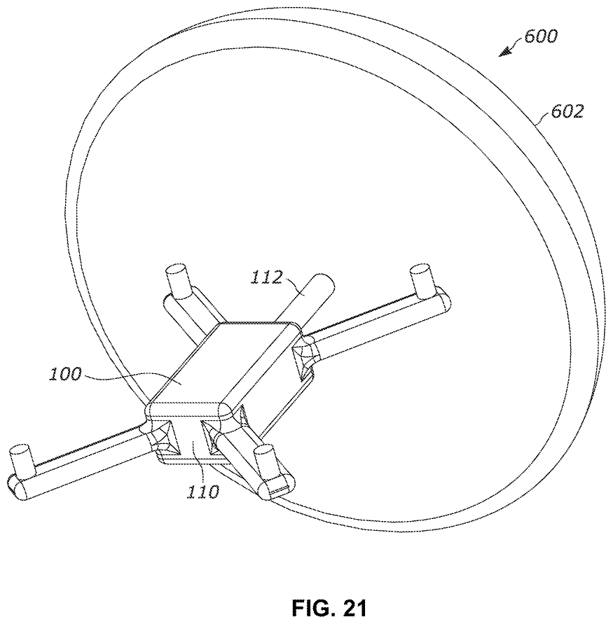

FIGS. 21-26 depict an inflatable bag 600. The inflatable bag 600 comprises a pouch 602 having an inward facing portion 606 and an outward facing portion 604. The inflatable bag 600 is capable of alternating between a deflated position and an inflated position.

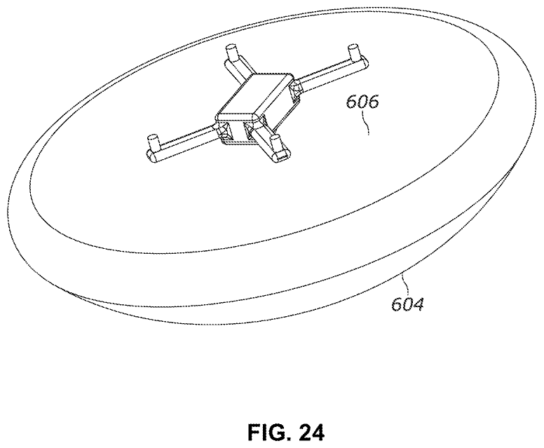

As depicted in FIGS. 21-23, the inflatable bag 600 may be attached to the front 108 of the drone 100 via an attachment means 112 in an inflated position. As depicted in FIGS. 24-26, the inflatable bag 600 may be attached to the bottom surface of the drone 100 via an attachment means 112. In alternate embodiments, the inflatable bag 600 may be attached to any surface of the drone 100.

In an embodiment, the drone 100 flies toward a firearm and applies the inflatable bag 600 to the firearm. The drone 100 applies force to the inflatable bag 600 to envelop and disable the firearm.

In an alternative embodiment, the inflatable bag 600 is loaded onto the drone 100 in a deflated position and is launched as a projectile at a target. Upon contact with the target, the inflatable bag 600 inflates and envelops a firearm. The bag 600 blocks the ejection port of the firearm and causes the weapon to malfunction.

The pouch 602 is comprised of a resin, plastic, or other sturdy lightweight materials including but not limited to Kevlar. Further, the inflatable bag 600 may house magnets, sand, metals, or other small particles.

In an embodiment, the outward facing portion 604 of the pouch 602 is coated with an adhesive to improve effectiveness of the inflatable bag 600. The inflatable bag 600 may be formed into any number of shapes in order to enhance the ability to disable a weapon.

In an embodiment, an adhesive and/or magnets are applied to the exterior of the inflatable bag 600. In this embodiment, the inflatable bag 600 applies the adhesive and/or magnets to the ejection port of the target firearm and disables the firearm. In this embodiment, even if the inflatable bag 600 is removed from the firearm, the adhesive and/or magnets remain in place on or in the ejection port of the target firearm and the weapon is disabled.

### Harpoon Device

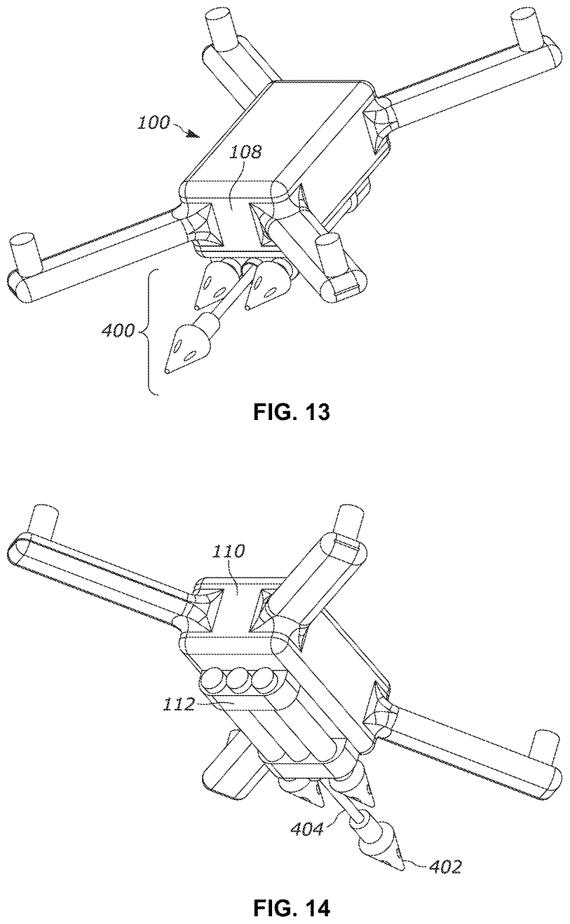

FIGS. 13-16 illustrate a harpoon device 400. The harpoon device 400 comprises a head 402 and a body 404. The head 402 comprises a tubular structure with a slotted opening on the face and contains a combination of materials capable of causing a weapon malfunction. The first end of the body 404 connects to the head 402 and may extend into the head 402 to act as a pusher rod inside of the tubular structure.

The head 402 comprises a release mechanism which, upon contact or close proximity to ferromagnetic components of a firearm, will release a mixture of materials to obstruct the ejection port, chamber and slide, or bolt of a weapon and interfere with the cycle of operations of a weapon. The first mixture of materials comprise metals, fabric, mesh, glue, putty, gel, cotton, steel wool, rare earth magnets and/or any similarly situated materials. In a preferred embodiment, the first mixture of materials comprise miniature rare earth magnets and dense non-ferrous particles, a capsule containing a solution of adhesive material (such as glue, putty, or the like), a combination of fibrous materials (such as cotton, steel wool, Kevlar, nylon threads, or the like). In an embodiment, the first mixture of materials further comprise a rare earth magnet that is approximately the same diameter as the tubular structure. The rare earth magnet may be coated in oil or grease and comprises 1-2 millimeter tines to puncture the capsule.

The head 402, upon contact or close proximity to ferromagnetic components of the target, will release the mixture of materials onto the target. The body 404 and/or magnetic energy of the mixture will force the mixture through a slotted opening on the outward face of the head 402. In a preferred embodiment, the tines on the rare earth magnet will puncture the capsule containing the adhesive material and the mixture will adhere to the frame of the target. The rare earth magnet, coated in oil or grease, will provide a protective layer for the first mixture, preventing removal of the material and providing time for the first mixture to attach firmly to the weapon, rendering it inoperable.

In the preferred embodiment, the body 404 of the harpoon device 400 is attached to the drone 100 via a connection means 112 with the head 402 of the harpoon facing the same direction as the front 108 of the drone. In an embodiment, a plurality of harpoons 406 are connected to the drone 100. In a preferred embodiment, the harpoon(s) 400 are arranged such that when fired together, cover an area equal to approximately five square inches.

In an embodiment, the drone 100 deploys the harpoon device by ramming the head 402 of the harpoon device 400 into the target. Upon contact, the head 402 detaches from the body 404 allowing the drone 100 to utilize additional harpoons 400 or perform other functions.

In an alternative embodiment, the drone 100 connects to a barrel 408 which launches the harpoon device 400 as a projectile at a target.

### Net

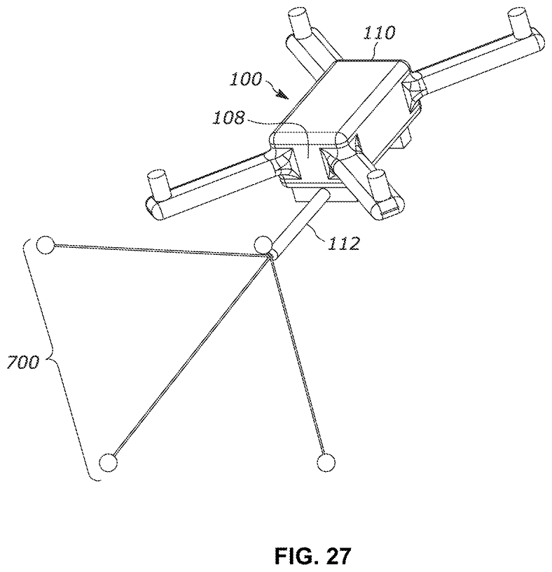

FIGS. 27-29 illustrate a net 700. The net 700 is comprised of a lightweight, fine mesh. An adhesive material is located along the center of the net 700 to ensure that the net 700 adheres to a target.

In the preferred embodiment, the net 700 is placed within a barrel 702, which is connected to the drone 100 via an attachment means 112. The barrel 702 launches the net 700 as a projectile at a target (preferably the ejection port of a firearm). The net 700 wraps around the firearm at the ejection port to cause the weapon to malfunction. The adhesive material located along the center of the net 700 ensures that the net maintains its position obscuring the ejection port.

### Claw 001

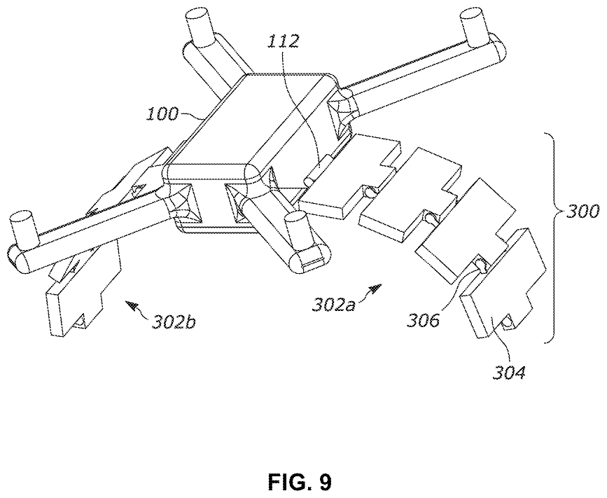

FIGS. 9-12, illustrate a latching device 300. The latching device 300 is attached to a drone 100 and comprises a plurality of arms 302a, 302b. The arms 302a, 302b are comprised of a plurality of plates 304, each connected by a rotatable connection 306. The rotatable connection 306 allows the plates 304 to rotate, which provides the arms 302 with a means to wrap around a target.

In a preferred embodiment, each arm 302 comprises a first end 308 connected to the drone via an attachment means 112 and a second end 310.

Prior to engaging a target, the arms 302 are in an open position, wherein the second end 310 of the arms 302 are spaced apart. Once a target is engaged, the arms 302 move into a closed position, wherein the arms 302 wrap around the target. In the closed position, the second 310 of the arms 302 are located proximate or are in contact with each other.

In a preferred embodiment, the drone 100 approaches a firearm and applies the latching device 300 by positioning the ejection port of the firearm within the arms 302 of the latching device 300 to cause the firearm to malfunction.

In an embodiment, an adhesive material is applied to the arms 302 of the latching device to improve the wrapping capability of the arms 302. In another embodiment, an expanding foam is applied to the arms 302 of the latching device 300, which expands upon contact with the firearm to envelop and disable the weapon.

In an alternative embodiment, the latching device 300 comprises a mount which is detachably connected to the attachment means 112 of the drone. The mount comprises a binding material, such as a magnet or adhesive material, to provide the latching device 300 with a means to attach to the target. In the alternative embodiment, the first ends 308 of the arms 302 are attached to the mount and the drone 100 deploys the latching device 300 by positioning the target within the arms 302 of the latching device 300. The latching device 300 detaches from the drone 100 and latches onto the target.

### Claw 002

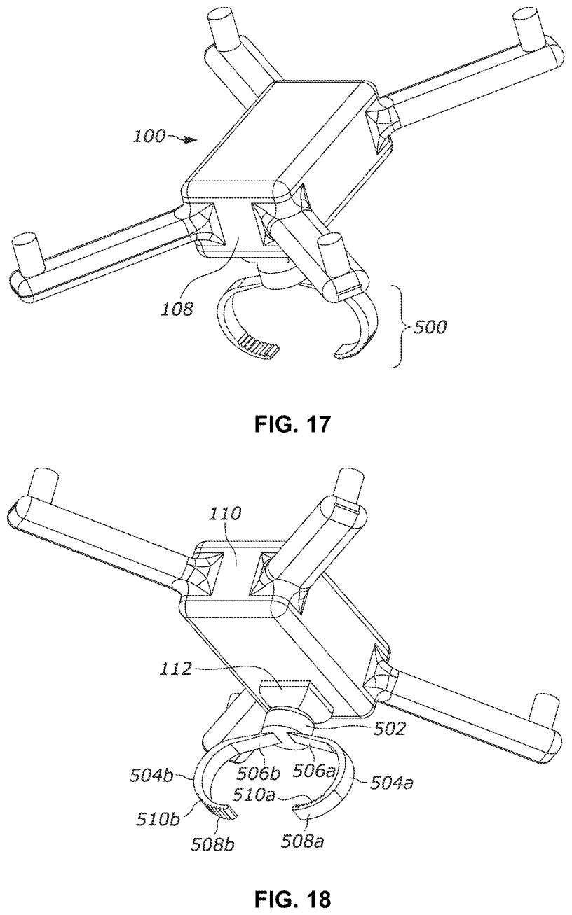

FIGS. 17-20 depict a two-pronged claw 500. The claw 500 comprises a mount 502 which detachably connects to the attachment means 112 of the drone 100. The claw 500 further comprises a first and second arm 504a, 504b. The arms 504a, 504b of the device form a generally parabolic shape, having a first end 506a, 506b connected to the mount 502 and an open second end 508a, 508b. The first ends 506a, 506b of the arms 504a, 504b are connected to a pivot or other rotating means to allow for movement of the arms in a co-planar direction.

The open second end 508a, 508b of the claw 500 is comprised of ratcheted teeth 510a, 510b. A first set of ratcheted teeth 510b runs along the exterior parabolic portion of the first arm 504b. A second set of ratcheted teeth 510a runs along the interior parabolic portion of the second arm 504a. The ratcheted teeth 510a, 510b are aligned such that when they contact each other the teeth lock into place.

In alternative embodiments, other mechanisms to latch the arms 502 together are considered.

In the preferred embodiment, the drone 100 deploys the claw 500 by positioning the target within the arms 504 of the claw 500 and latching the arms 504 together.

### Drone Squad (Swarm)

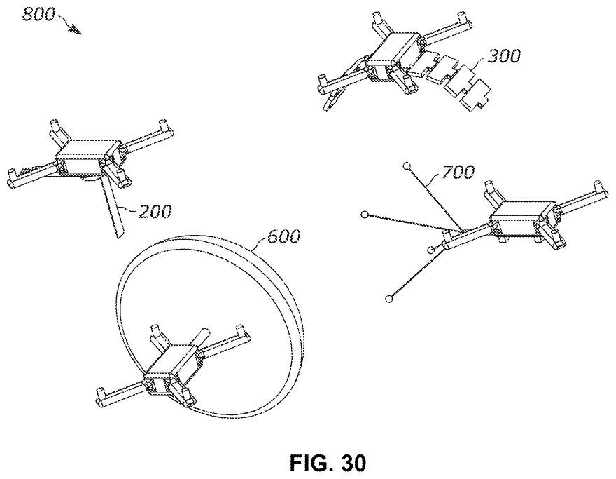

FIG. 30 depicts a set of drones and drone attachments 800 comprising a “swarm” capable of interacting with each other to disable a target.

The swarm consists of multiple UAVs utilizing onboard/embedded computer vision models to autonomously interact with the “target” and environment. The swarm comprises at least two UAVs in order to optimize information gathering capabilities, perform disruption/diversionary tactics, and increase probability of successful disarming of the target. The swarm is also utilized as redundancy to mitigate anti-drone countermeasures taken by the target. Each UAV in the swarm includes one or more unique capabilities and may carry out individual and coordinated tasks to accomplish a unified mission to interrupt the target firearm's cycle of operations by either striking the firearm with a firearm malfunction device or preventing the target from accessing the firearm.

In an embodiment, the UAVs in the swarm circle above the target to collect and disseminate real-time video and data to key/critical personnel. The UAVs circling above the target may travel in clockwise or counterclockwise directions while keeping their cameras and computer-vision sensors trained on the target.

In an embodiment, the swarm comprises multiple drones and has the ability to malfunction multiple firearms at once. In this embodiment, the swarm comprises a combination of the firearm malfunction devices disclosed in this application. In alternative embodiments, other firearm malfunctioning devices may be used in connection with the swarm.

In an embodiment, the swarm comprises a plurality of drones to monitor the target and disseminate real-time video to key/critical personnel. In this embodiment, the swarm further comprises one or more firearm malfunction devices disclosed in this application to disable the target firearm. In alternative embodiments, other firearm malfunctioning devices may be used in connection with the swarm.

### Electromagnetic Drone/Martyr Drone

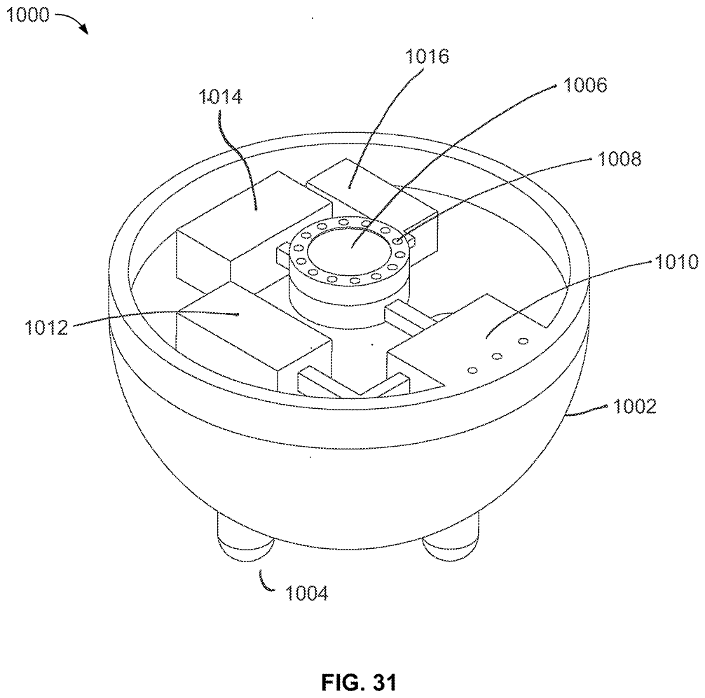

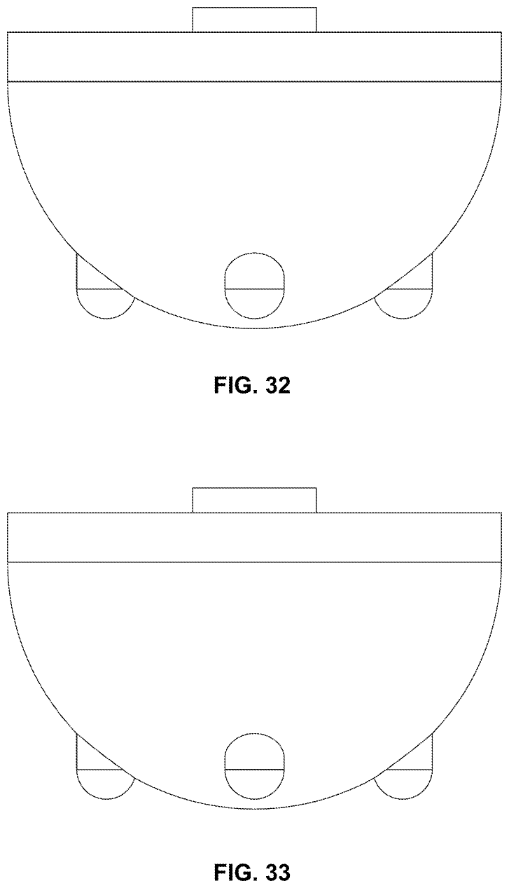

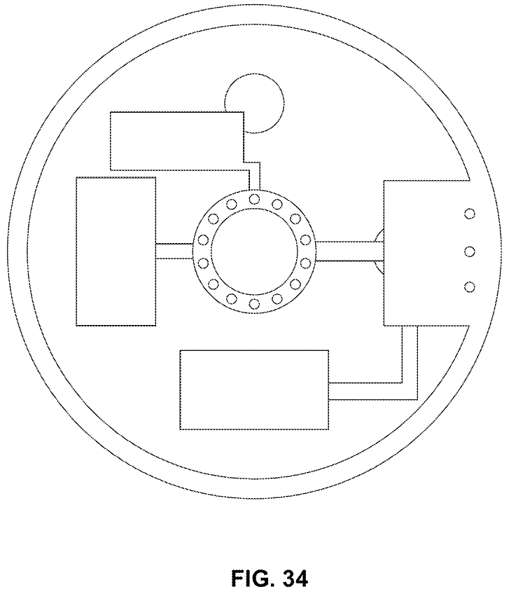

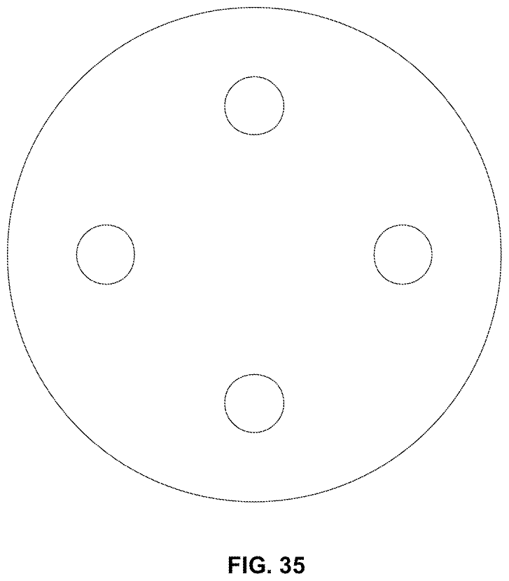

FIGS. 31-35 depict an electromagnetic drone 1000. The purpose of the electromagnetic drone 1000 is to target and attach itself to the ejection port of a firearm. In an alternative embodiment, the electromagnetic drone 1000 may inject a solution such as an expanding foam, glue, gel, or solid particle onto the firearm to cause a malfunction.

The electromagnetic drone 1000 comprises an exposed electromagnet 1006 protruding from the bottom of the drone, an electromagnet battery 1014, a protective shell 1002 to protect the electromagnet battery 1014, a storage compartment for the foam solution 1016, and holes or vents 1008 along the electromagnet for dispensing the foam solution.

A plurality of rotors 1004 are connected to the top of the drone 1000. The rotors are powered by a second battery 1012. A control system 1010 is operatively connected to the rotors 1004 and the second battery 1012 to control the rotors 1004 and guide the drone 1000.

The storage compartment 1016 is attached to the electromagnet 1006 and corresponding holes 1008. An actuator controls the volume of foam solution released by the drone 1000.

The drone 1000 may further comprise sensors and a camera on the shell 1002 of the drone 1000.

In the preferred embodiment, the electromagnetic drone 1000 will fly within close proximity of its target (i.e., the firearm) and activate the electromagnet 1006. The electromagnetic drone 1000 then discontinues its flight and uses the magnetic energy of its surface to cover the remaining distance to the target. Once the electromagnetic drone 1000 makes contact, the magnetic energy ensures that the electromagnetic drone 1000 adheres to the target, rendering the firearm inoperable.

If the electromagnetic drone 1000 fails to make contact with the target, the drone 1000 will demagnetize, take flight, and approach the target again.

In alternative embodiments, the electromagnetic drone 1000 administers a foam-like substance to the ejection port to render the target inoperable. Further, the electromagnetic drone 1000 may administer an adhesive substance to improve the sealing capacity of the electromagnetic drone 1000.

### Foldable Drone

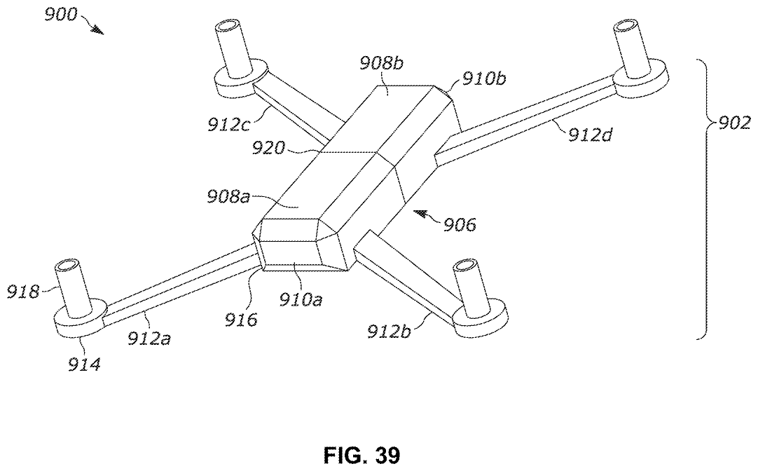

FIGS. 39-43 depict a foldable drone 900. The foldable drone 900 alternates between a flight configuration 902 and a grapple configuration 904. During the course of standard flight, the foldable drone 900 operates in flight configuration 902. As such, the foldable drone 900 operates as a standard drone and comprises a body 906, a plurality of arms 912, a plurality of rotors 918 and rotor blades extending from the rotors (not depicted).

The foldable drone 900 further comprises a body hinge 920 which connects the front portion 908a to the back portion 908b of the drone. The body hinge 920 provides a means for the front and back portions 908a, 908b to bend at the hinge as shown in FIG. 48. Along the front portion 908a of the drone is a front surface 910a and along the back portion 908b of the drone is a back surface 910b.

The arms 912 of the drone comprise a first end connected to the body 906 by a hinge 916. The hinge 916 provides a means for the arms 912 to bend at the hinge as shown in FIG. 48. The arms 912 also comprise a second end 914, from which extend the rotors 918.

In an embodiment, the foldable drone 900 approaches and flies directly into the target (i.e., the firearm) to disarm and disable the threat.

In an embodiment, the drone approaches a target (i.e., the firearm) and hovers above the ejection port. Once the foldable drone 900 is positioned, it engages its grapple configuration 904 and bends its body 906 and arms 912 at the hinges 916, 920 to wrap around the firearm. The foldable drone 900 adheres to the firearm at the ejection port and prevents the ejection of cartridge(s) and causes the firearm to malfunction.

In an alternative embodiment, the foldable drone 900 releases a mixture of foam, chemicals, sand, magnets, and the like to jam the ejection port of the firearm.

In another alternative embodiment, the second end 914 of the arms 912 include an adhesive material, magnets, and/or locking hinges to improve the wrapping capability of the foldable drone 900 and stick to the firearm.

### Firearm Malfunction UAV

FIG. 44 depicts an exploded view of a firearm malfunction UAV 1100 (or alternatively, a drone). The drone depicted in FIG. 44 comprises a propeller sub-assembly 1200, a plurality of propellers 1300 and other modules, a central frame 1400, internal components 1500, a top frame 1600, and a battery pack system 1700. Each of these elements is described in further detail below.

### Propeller Guard Sub-Assembly

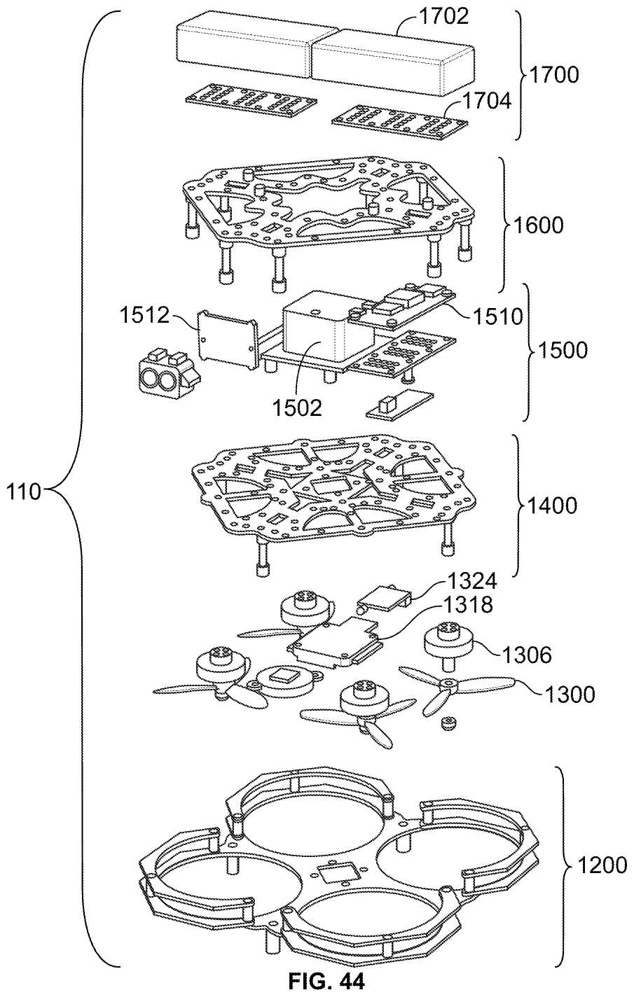

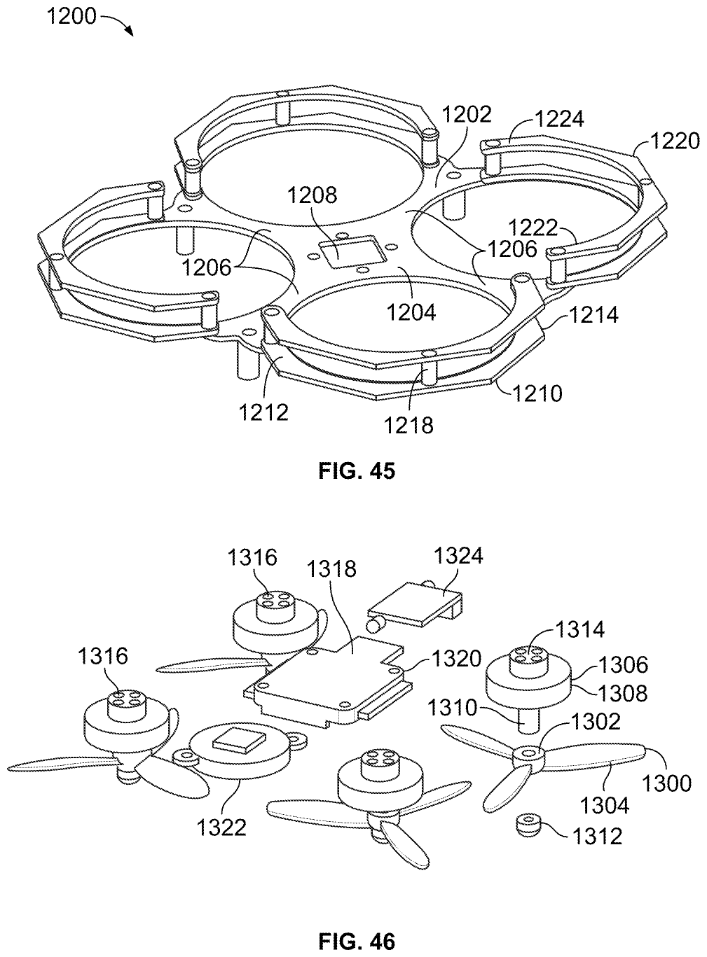

The drone comprises a propeller guard sub-assembly 1200 as is depicted in FIG. 45. The propeller guard sub-assembly 1200 provides a supportive frame to protect the propellors 1300 as they rotate. The propeller guard sub-assembly 1200 guards rotation of the propellers 1300 against potentially damaging objects (such as a wall, or other object that the drone 110 may accidentally encounter) or injuring individuals. The propeller guard sub-assembly 1200 comprises a bottom frame 1202, a bottom propellor frame 1210, a plurality of support beams 1218, and a top propellor frame 1220. The bottom frame 1202 comprises a hub 1204 with a plurality of arms 1206 extending therefrom.

The hub 1204 is positioned centrally on the bottom frame 1202. In addition, the bottom frame 1202 may comprise an opening 1208 proximate the hub 1204. Each arm 1206 extends away from the hub. Each arm 1206 (proximate the end of each arm 1206) connects to a bottom propeller frame 1210 as depicted in FIG. 45. The bottom propellor frame 1210 comprises a first end 1212 and a second end 1214, wherein the first end 1212 connects to a first arm 1206 and the second end 1214 connects to a second arm 1206.

In the embodiment shown in FIG. 45, the bottom propeller frame 1210 forms an arc between the first end 1212 and second end 1214 with a radius greater than the propeller 1300 length to allow for unimpeded movement of the propellers 1300. In alternative embodiments, other shapes may be used which do not impede the rotation of the propellers 1300 of the drone 1100.

In the embodiment shown in FIG. 45, the arms 1206 attached to each bottom propeller frame 1210 form corresponding arcs having a radius greater than the propeller 1300 length to allow for unimpeded movement of the propellers 1300. In this embodiment, the apex of the arc is proximate the hub 1204. In alternative embodiments, other shapes may be used which do not impede the rotation of the propellers 1300 of the drone 1100.

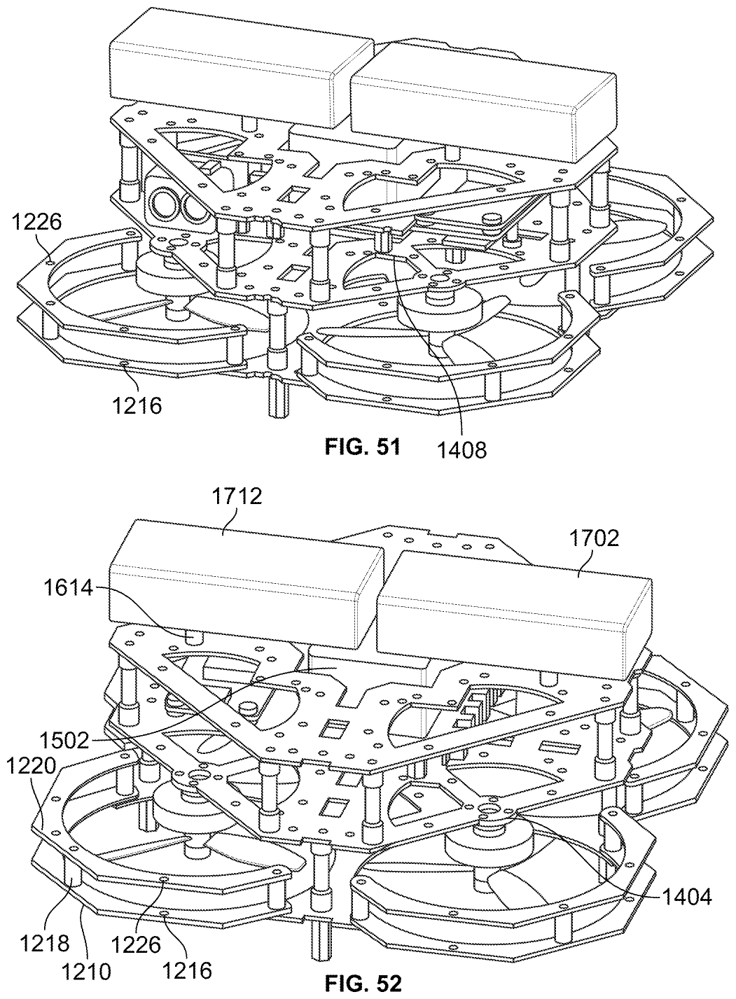

In addition, each bottom propellor frame 1210 contains a plurality of apertures 1216 (shown on FIG. 51). The apertures 1216 facilitate mounting or connecting the bottom propeller frame 1210 to the top propeller frame 1220 or other components of the drone 1100 or drone housing 1800.

The bottom propellor frame 1210 is connected to the top propellor frame 1220 by means of several support beams 1218. Each top propellor frame 1220 comprises a first end 1222 and a second end 1224. In the embodiment shown in FIG. 45, the first end of the top propeller frame 1222 connects to and aligns with the first end 1212 of the bottom propeller frame and the second end of the top propeller frame 1224 connects to and aligns with the second end of the bottom propeller frame 1214. The top propeller frame 1220 may comprise a plurality of apertures 1226 (shown on FIG. 51) to facilitate mounting or connecting the top propeller frame 1220 to the bottom propeller frame 1210 or other components of the drone 1100 or drone housing 1800.

In the embodiment shown in FIG. 45, the first end of the top propeller frame 1222 is attached to the first end of the bottom propeller frame 1212 by means of a support beam 1218 and the second end of the top propeller frame 1224 is attached to the second end of the bottom propeller frame 1224 by means of another support beam 1218. Additional (or fewer) support beams 1218 may be used to connect the top frame 1220 and bottom frame 1210. The space between the top propellor frame and the bottom propellor frame allows air to flow more freely around the drone's 1100 propellors 1300.

In an embodiment, a variety of devices may be placed within the opening 1208, including but not limited to a downward facing Lidar sensor, optical flow sensor, and/or camera. Alternatively, the opening 1208 may provide a connection for any one of the firearm malfunction devices (including but not limited to the airbag actuator device 2800 and malfunction plate 2200, 2300, 2400, 2500, 2600, 2700) disclosed herein.

In an alternative embodiment, the propeller guard sub-assembly 1200 may be comprised of a single integral piece.

Generally, the propeller guard sub-assembly 1200 will consist of four arms which attach to four bottom propellor frames 1210 which connect and correspond to four top propellor frames 1220 to protect the four propellers as depicted in FIG. 45.

Alternative embodiments may comprise any number of top and bottom propeller frames 1210, 1220 to correspond to any number of propellers 1300 used in a drone 1100.

The propeller guard sub-assembly may comprise a plurality of feet along the bottom of the bottom frame 1202. The plurality of feet may be located proximate the ends of the arms 1206 or proximate the hub 1204 of the bottom frame 1202.

The propeller guard sub-assembly 1200 may be comprised of any plastic, metal, carbon fiber, or other material suitable to protect the rotation of the drone's 1100 propellers 1300.

In an embodiment, the propeller guard sub-assembly 1200 is constructed using 1.5 mm, flat carbon fiber plates. In this embodiment, a plurality of fasteners may be used to connect the bottom propeller frame 1210 and the top propeller frame 1220 to the support beams 1218. In this embodiment, the fasteners may be M3 (3 mm) titanium or 304 stainless steel bolts. In an embodiment, the support beams 1218 are approximately 10 mm in length.

The purpose of the propeller guard sub-assembly 1200 is to reinforce the drone 1100, protect the drone's propulsion system from damage induced by impacts, and protect bystanders from injury.

### Motor and Propellors

The drone 1100 comprises at least one propeller 1300 and other components as depicted in FIG. 46.

As depicted in FIG. 46, the drone 1100 is propelled by at least one propeller 1300 comprising a plurality of propeller arms 1304 extending from a propeller hub 1302. Each propeller 1300 is powered by a propeller motor 1306. Each propeller motor 1306 comprises a propeller engine 1308, a propeller rod 1310, a propeller nut 1312, a propeller mount 1312, and a plurality of apertures 1314. The propeller engine 1308 impels the propeller rod 1310, which drives the rotation of the propeller 1300. The rod 1310 extends from the propeller engine 1308 and through the propeller hub 1302. The propeller nut 1312 is attached to the end of the rod 1310 to prevent the propeller 1300 from disassembling from the rod 1310. The propeller engine 1308 is connected to a propeller mount 1314 (which comprises a plurality of apertures 1316 to facilitate mounting or connecting the propeller and propeller motor 1300, 1306 to the central frame 1400 or other part of the drone body 1100.

The embodiment depicted in FIG. 46 depicts a motor hub 1318, also referred to as an electronic speed controller by those in the art. In this embodiment, the motor hub 1318 is operatively connected to each motor 1306 within the drone 1100 and activates and modulates the propeller engines 1308 to rotate the propellers 1300 and provide propulsion for the drone 1100. The motor hub 1318 comprises a plurality of apertures 1320 to facilitate mounting or connecting the motor hub 1318 to the central frame 1400 or other part of the drone body 1100. The motor hub 1318 is also be operatively connected to a flight controller 1502.

A power module 1324, also referred to as a power distribution board by those in the art, is operatively connected to and provides power for the motor hub 1318. The power module 1324 may be operatively connected and provide power to any other modules, batteries 1702, or internal components 1502.

In an embodiment, the drone 1100 further comprises a speaker module 1322. The speaker module 1322 is configured to emit a noise which can aid in disarming and distracting an armed target. The speaker module 1322 comprises a plurality of apertures to facilitate mounting or connecting the speaker module 1322 to the central frame 1400 or other part of the drone body 1100.

As depicted in FIG. 46, the drone 1100 comprises four propellors and propeller motors 1300, 1306, although any number of propellors may be utilized in connection with the drone 1100. Each propellor 1300 preferably comprises three arms 1304, but other numbers of arms are also contemplated by this disclosure. In an embodiment, the propellers 1300 may be comprised of a plastic, wood, metal, or material. In an embodiment, the propeller motors 1306 may be comprised of a stainless steel and copper wiring.

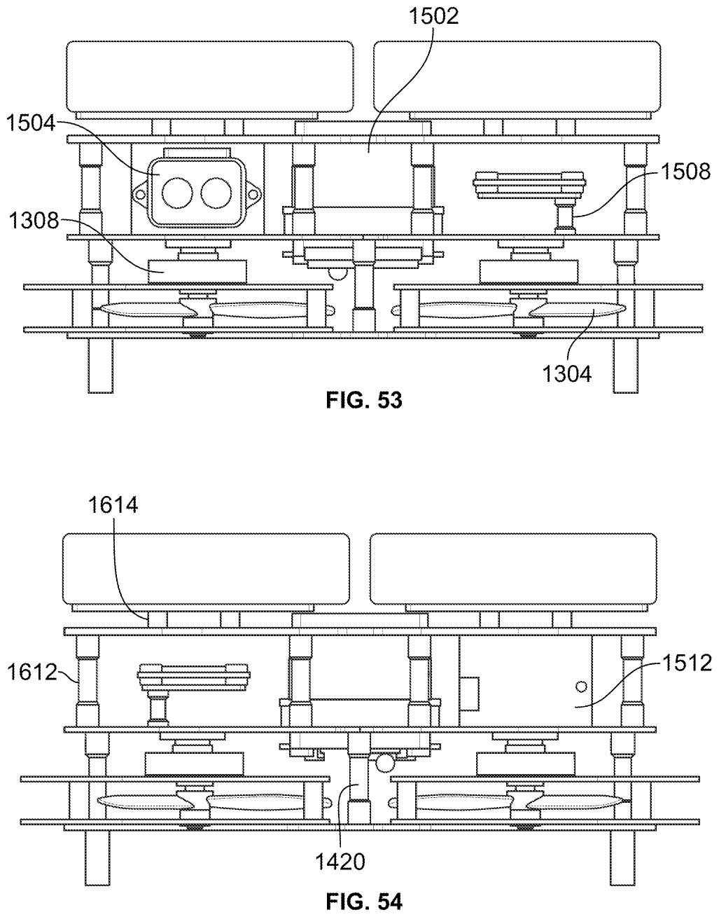

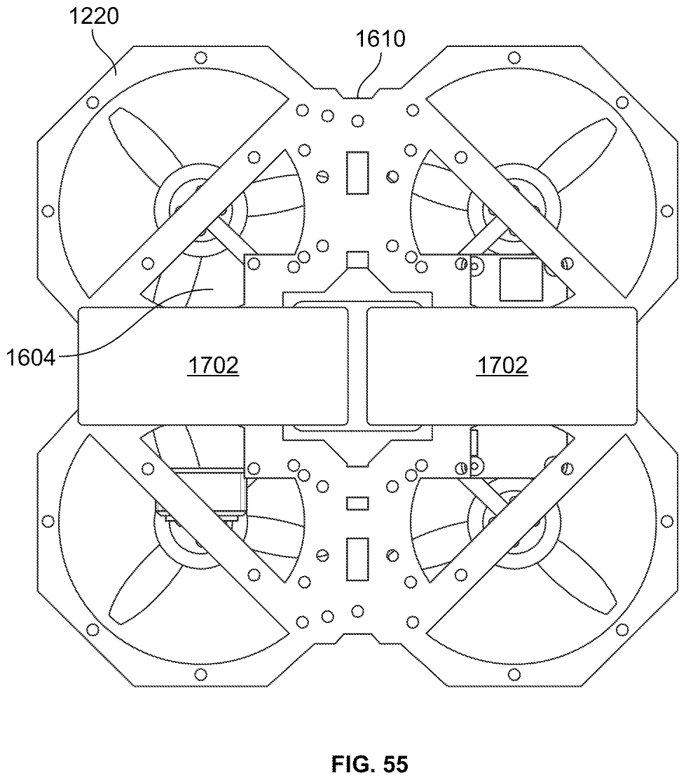

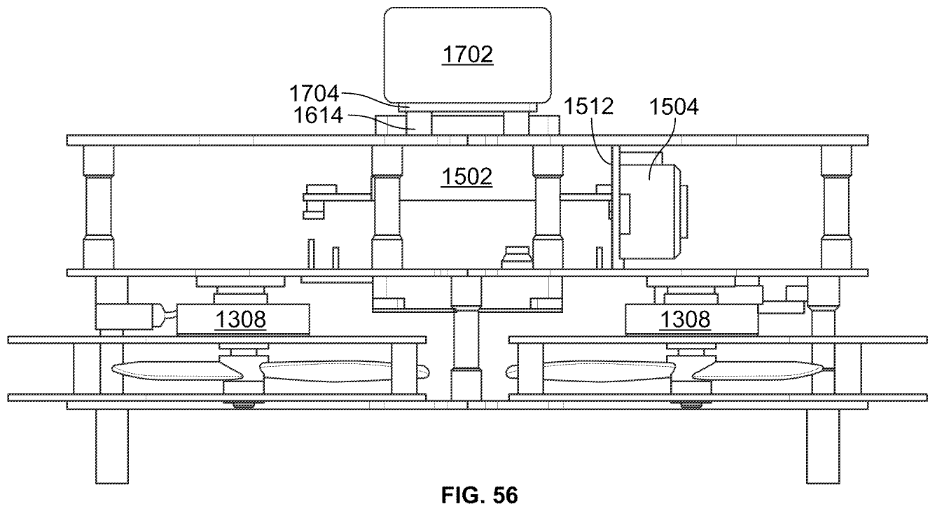

Unlike other drones, the propellors 1300 of the drone 1100 depicted in FIGS. 51-56 are located proximate the bottom of the drone 1100. As described in later paragraphs of this application, the location of the propellors assist with cooling the drone. Further, this location allows for the development of a compact drone.

In the preferred embodiment, the drone 1100 construction is modular is design. Each of the internal components 1502 and other modules (such as the speaker module 1322, power module 1324, motor hub 1318, etc.) may be placed anywhere within the drone and may be attached to any portion of the central frame 1400 or top frame 1600. The primary purpose of the modular design is to allow future technologies to be incorporated into the central frame 1400 or top frame 1600 of the drone. Any of the internal components 1502 or other modules (such as the speaker module 1322, power module 1324, motor hub 1318, etc.) may be secured to a mounting plate 1512 which is engineered to detachably connect to the central frame 1400 and top frame 1600. The mounting plate 1512 eliminates the requirements for extra bolts, nuts, and washers to fasten the internal components 1500 or other modules in place and results in a weight reduction of the drone. The apertures 1416, 1608 located throughout the central frame 1400 and top frame 1600 allow for the mounting plates 1512 to be arranged in any location throughout the drone 1100.

In a standard drone or UAV design, the motors and propellers are spaced apart from and above the main body of the drone/UAV. This spacing is generally used in standard UAV's and drone's to have greater clearance and unobstructed rotation of the propellers. In the standard design, the propellers (located above the drone body), “pull” the rest of the drone body upwards.

In the preferred embodiment of the present disclosure, the drone's motors 1306 and propellers 1300 are inverted, turning the propulsion system into a “pusher” instead of a “puller” design. In other words, the propellers (acting from beneath the drone 1100) push the drone body 1100 upwards to achieve propulsion. Further, in the present disclosure, the propeller motors 1306 are located proximate the bottom of the drone 1100. Placing the propeller motors 1306 under the central frame 1300 reduces the overall footprint (i.e., the size) of the drone.

Further, the location of the propeller motors 1306 is a key component of the cooling system of the drone. Specifically, the location of the motors 1306 and propellers 1300 creates a suction effect which pulls fresh air from the rear-facing air inlets 2050 of the drone housing 2000 (discussed below) into the body of the drone 1100. This passage of air cools all of the internal components 1502, modules, and motors 1306 of the drone 1100.

Traditional drone/UAV cooling is provided by the forward movement of air passing through the drone as the drone is in flight. The traditional method often requires additional cooling means, such as the implementation of fans. However, additional fans result in a disadvantage to the drone. Specifically, these fans increase the weight and power requirements of the drone, which has an impact on flight times and drone compactness.

The drone 1100 of the present disclosure does not require additional cooling means due to the motor 1306 and propeller 1300 placement.

### Central Frame

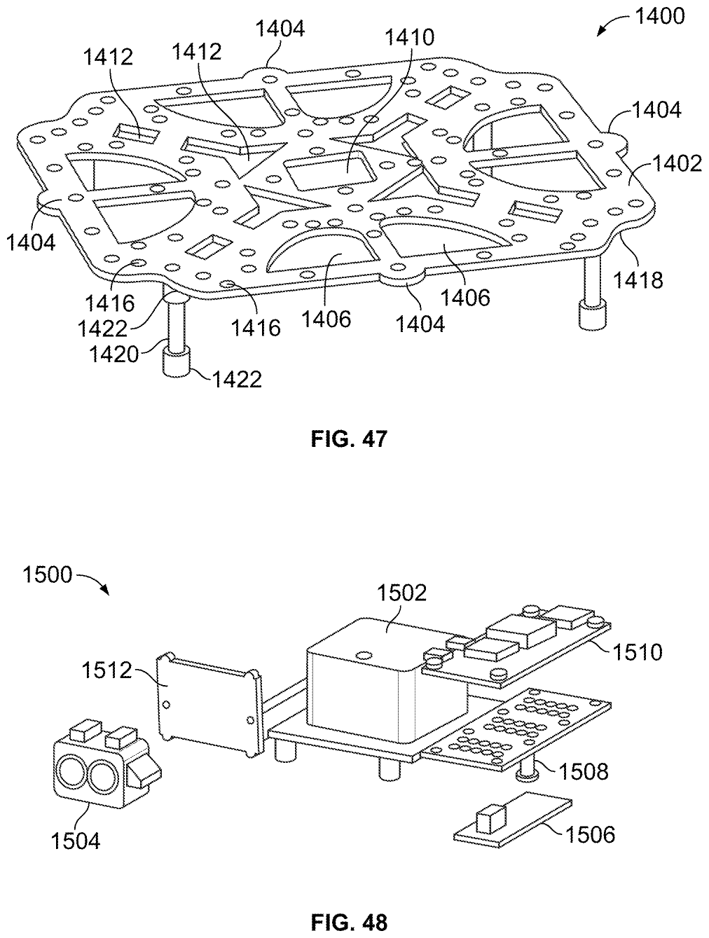

As depicted in FIG. 47, the drone 1100 comprises a central frame 1400.

The central frame 1400 provides structural support for the drone 1100 and allows other components of the drone to be affixed to the drone body 1100. As depicted in FIG. 47, the central frame 1400 further comprises a central sheet 1402 and support beams 1420. Along the edges of the central sheet 1400 is a plurality of motor connections 1404 whereby the propeller motors 1306 (via the propeller mounts 1314) may connect to the central frame 1400. In addition, the central frame 1400 may comprise a plurality of apertures 1416 throughout the central sheet 1402 as well as a central opening 1410 proximate the center of the central sheet 1402. The central opening 1410 is positioned in the center of the central frame 1400 and permits the passage of air around the motor hub 1318 which is preferably connected to the central sheet 1400 proximate the opening 1410.

In the preferred embodiment, depicted in FIG. 47, the central frame 1400 comprises a series of cutaways portions 1406 and air passages 1412 throughout the central frame 1400 as well as rounded corners 1418. Other embodiments of various sized and shaped cutaways 1406 and/or air passages 1412 are considered.

In the embodiment depicted in FIG. 47, the cutaways 1406 are shaped in quarter circles and allow air to pass through the central frame 1400 as the drone 1100 flies through the air. Some of the quarter circle cutaways 1406 may further comprise a notched portion 1408 as depicted in FIG. 51. The central frame 1400 has additional air passages 1412 to facilitate air flow through the drone body 1100 to the propellors 1300, internal components 1500, and other modules. The central frame 1400 comprises additional apertures 1416 to facilitate mounting or connecting internal components 1500, and other modules (including but not limited to the speaker module 1322, power module 1324, and motor hub 1318) to the central frame 1400. The apertures 1416 may also be used to connected the central frame 1400 to the top frame 1600.

In the embodiment depicted in FIGS. 51-57, the central frame 1400 is detachably connected to the propeller guard sub-assembly 1200 via a plurality of support beams 1420, each of the support beams have mounting portions 1422 on both sides of the support beams 1420.

In an embodiment, the central frame 1400 is comprised of a 1.5 mm thick carbon fiber plate. In an embodiment, the support beams 1420 are comprised of stainless steel and a plurality of fasteners (such as 3 mm stainless steel or titanium bolts) may be used to connect the support beams 1420 to the central frame 1400 and sub-assembly 1200.

### Internal Components

Multiple internal components 1500 of the drone system are disclosed as depicted in FIG. 48. These internal components 1500 aid the drone's 1100 maneuverability and ability to interact with a target. The embodiment of FIG. 48 depicts a flight controller 1502 (such as a Hex Cube, VOXL, or other flight controller system). The flight controller 1502 ensures that temperature is standard for all internal components 1502 within the drone and serves as an anti-vibration stand-off.

The embodiment of FIG. 48 further discloses a lidar system 1504. Lidar, or “light detection and ranging” is a technology known in the art which assists the drone in determining altitude and position within an environment by emitting a laser and measuring the amount and direction of light which bounces back.

The embodiment of FIG. 48 further discloses a telemetry system 1506 which assists the drone 1100 to determine its location as it moves throughout an environment as well as a companion computer 1510 (such as a Raspberry or Snapdragon computer system).

A mounting plate 1512 may be used to secure additional components to the drone. As depicted in FIG. 91, the mounting plate comprises a top 1512a, a bottom 1512b, and notches 1512c along the top 1512a and/or bottom 1512b of the mounting plate 1512.

In the preferred embodiment, the mounting plate 1512 is comprised of a carbon fiber material for a strong, rigid, slightly flexible frame. In an alternative embodiment, other materials providing for a strong, rigid, flexible frame may be used. As describe above, the mounting plate 1512 enables modularity of the internal components. In addition, the mounting plate 1512 reduces electromagnetic interference and assists in the absorption of radio frequencies that may impact the operation of the internal components. The mounting plate(s) 1512 expand and contract with temperature changes in various environments. This helps to keep the overall shape of the drone 1100 stable while it operates in a dynamic environment.

In the embodiment depicted in FIGS. 51-57, the lidar 1504 system is connected to a mounting plate 1512, which in turn is secured to the central plate 1400 and top plate 1600 via the notches 1512c which fit within the apertures 1416, 1608. Other modules and internal components 1500 may be secured to the central frame with the mounting plate 1512.

Further, the embodiment of FIG. 48 depicts a standoff hex 1508, which attaches to the companion computer 1510. The standoff hex 1508 comprises a plurality of apertures to and creates an air gap between the central frame 1400 and the computer 1510 to improve air flow and cooling around the computer 1510. A standoff hex 1508 may be used with any of the internal components 1500 (and as shown in FIG. 48, the flight controller 1502 rests on top of a modified standoff hex).

### Top Frame

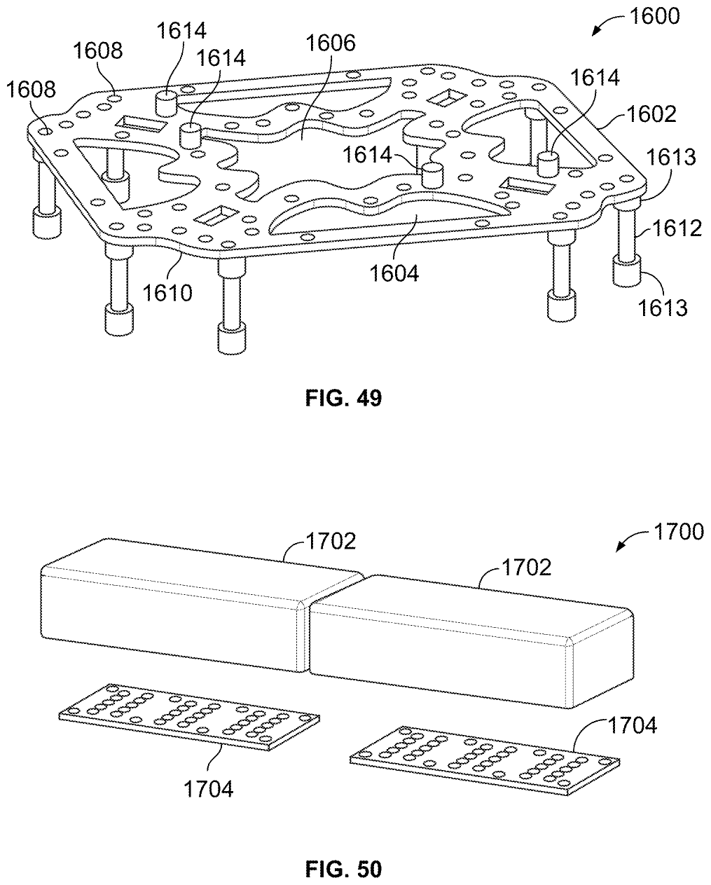

As depicted in FIG. 49, the drone 1100 comprises a top frame 1600.

The top frame 1600 provides structural support for the drone 1100 and allows other components of the drone to be affixed to the drone body 1100 (similar to the central frame 1400). As depicted in FIG. 49, the top frame 1600 further comprises a top sheet 1602, bottom support beams 1612, and top support beams 1614. In addition, the top frame 1600 may comprise a plurality of apertures 1608 throughout the top sheet 1602 as well as a central opening 1606 proximate the center of the top sheet 1602. The central opening 1606 is positioned proximate the center of the top frame 1600 and permits passage of air around the flight controller 1502 (wherein the flight controller 1502 is attached to the central frame 1400 and partially extends through the opening 1606).

In the preferred embodiment, the flight controller 1502 fits squarely within the opening 1606 and the sides of the flight controller 1502 are flush with the edges of the opening. Alternative arrangements of the flight controller and top frame 1600 are considered. In an alternative embodiment, the frame 1600 does not comprise a central opening 1606.

In the preferred embodiment, and as depicted in FIG. 49, the top frame 1600 comprises a series of cutaway portions 1604 and air passages 1608 throughout the top frame 1600 as well as rounded corners 1610. Other embodiments of various sized and shaped cutaways 1604, air passages 1608, and corners 1610 are considered. The cutaways and air passages permit additional air flow through the drone body 1100.

The top sheet 1602 further comprises additional apertures 1608 to facilitate additional devices or components to be mounted to the top sheet 1602, including the bottom support beams 1612 and top support beams 1614. The bottom support beams 1612 each comprise mounting portions 1613 to connect to other components of the drone body, such as the propellor sub-assembly 1200 and the central frame 1400. The top mounting portions 1614 connect to the battery pack system 1700.

In an embodiment, the top frame 1600 is comprised of a 1.5 mm thick carbon fiber plate. In an embodiment, the support beams 1612, 1614 are comprised of stainless steel and a plurality of fasteners (such as 3 mm stainless steel or titanium bolts) may be used to connect the support beams 1612, 1614 to the central frame 1400, the top frame 1600, and/or battery pack system 1700.

### Batteries

The drone 1100 comprises a battery pack system 1700 as depicted in FIG. 50. The battery pack system 1700 comprises at least one battery 1702 and is operatively connected to the power module 1324.

The at least one battery (or batteries) 1702 may be any battery-type known in the art including but not limited to, rechargeable batteries, single-use batteries, alkaline batteries, lithium ion batteries, or any other primary cell or secondary cell-type electric battery known.

In the embodiment depicted in FIG. 50, the battery pack system 1700 comprises two batteries 1702, but may contain an additional number of batteries, as may be required for a particular use. In the preferred embodiment, the battery pack system 1700 is detachably connected to the top frame 1600 of the drone 1100 by a plurality of top support beams 1614.

Optionally, and depicted in FIG. 50, the battery pack system 1700 further comprises a plate channel 1704 for each battery 1702 used in the battery back system 1700. In the preferred embodiment, each battery 1702 rests on a plate channel 1704 which is attached to the top support beams 1614. In alternative embodiments, no plate channels 1704 are required.

The plate channels 1704 comprise a plurality of cutaway portions and apertures to facilitate the mounting of the batteries 1702 to the plate channels 1704 and provide additional airflow and cooling around the battery 1702 as the drone 1100 is in flight.

In an embodiment, the batteries 1702 are lithium polymer batteries comprising two cells having 2200 Mah. The batteries 1702 are connected in series resulting in four total cells producing approximately 16-17 volts to power the UAV. The batteries 1702 have a discharge rate of at least 75 C to provide the aircraft with power when demanded by the flight controller 1502.

In an embodiment, the batteries 1702 are wirelessly chargeable. In this embodiment, the wireless charging solution may use induction coils to convert AC to DC voltage and provide power to the UAV.

In an embodiment, the batteries 1702 comprise an onboard processor that discharges the battery's voltage to a requisite level during charging. The onboard processor is also known as a battery management system (BMS) and prevents lithium polymer batteries from being in a state of distress. A BMS system offers overcharge protection so that the batteries cannot accept more power than can be stored, thus preventing the chance of spontaneous combustion. A BMS also provides readings for each battery's state of health, state of charge, temperature, and voltage per cell data which can be used by an operator to determine the overall battery health and safety. The BMS system also uses an internal process to put the battery in storage mode after a pre-programmed period of non-use to extend the life of the battery. Storing the battery fully charged is detrimental to battery health and can lead to spontaneous combustion or implosion of battery cells.

### Drone Housing

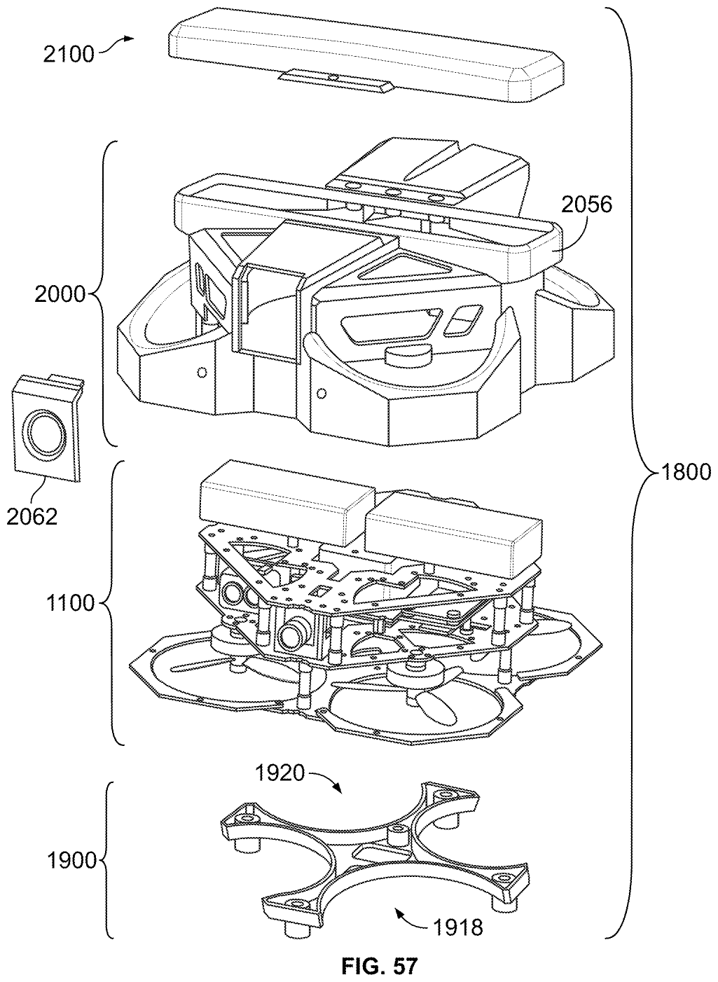

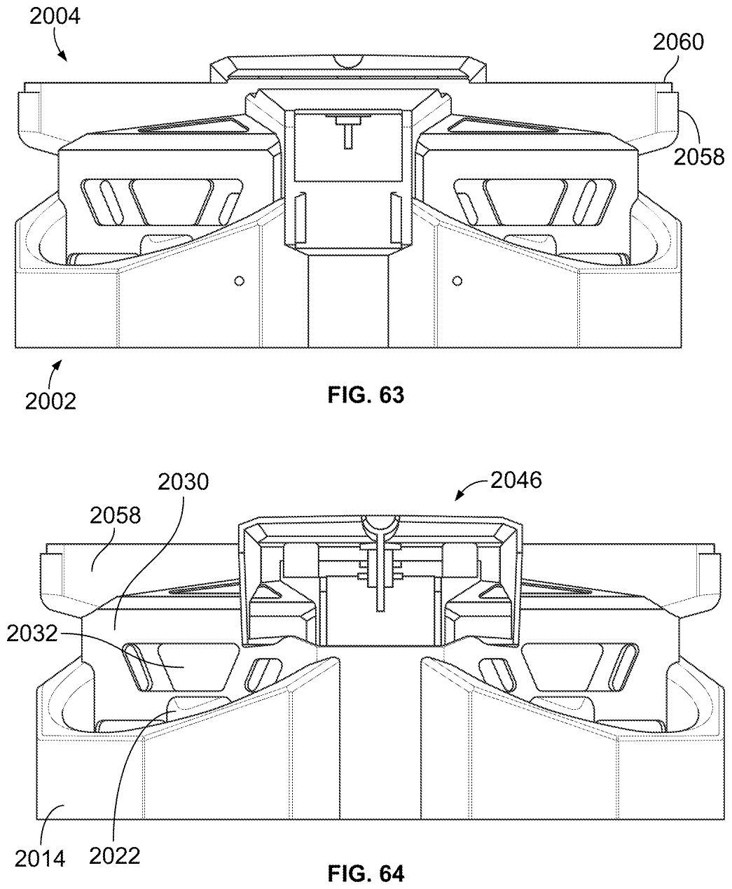

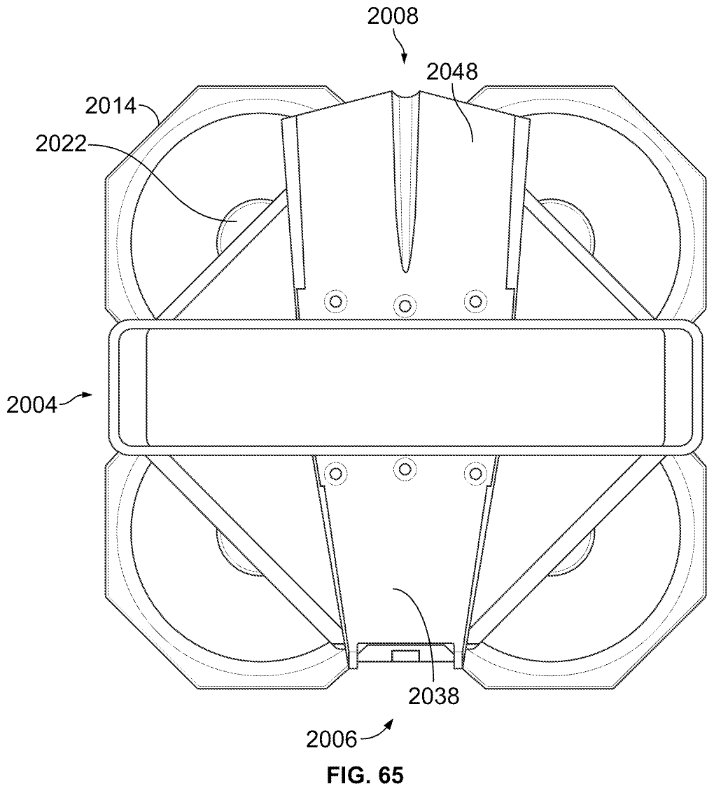

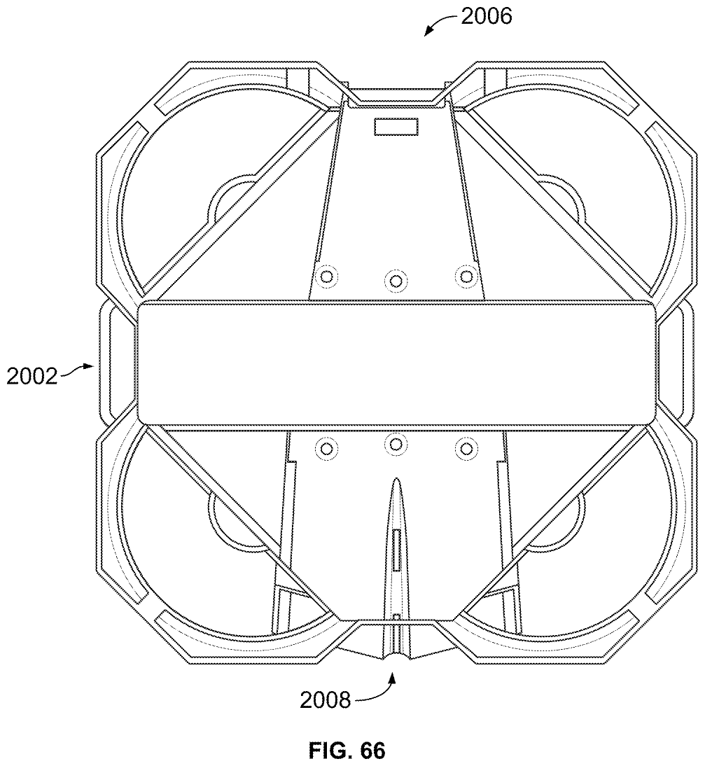

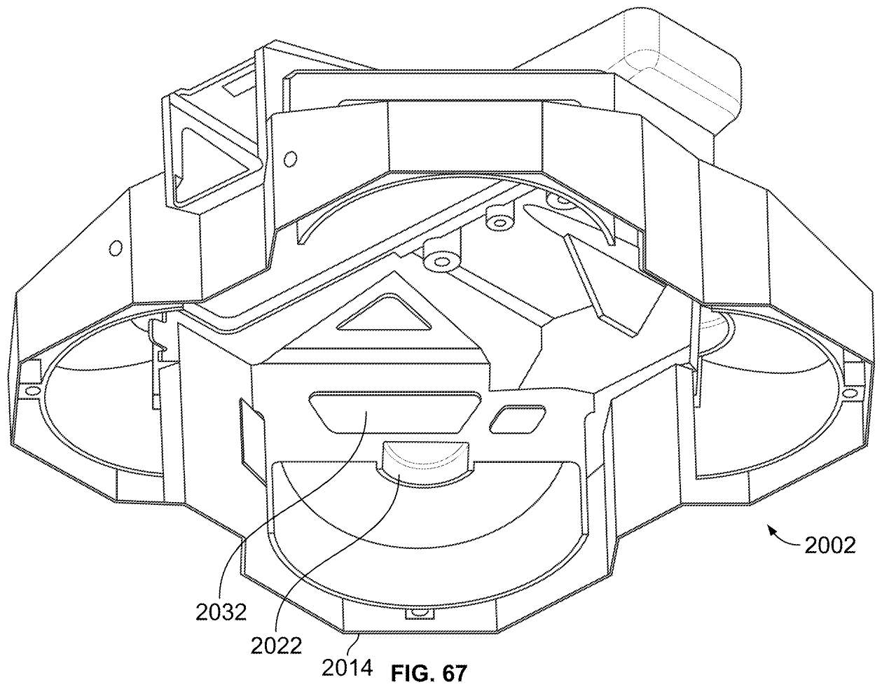

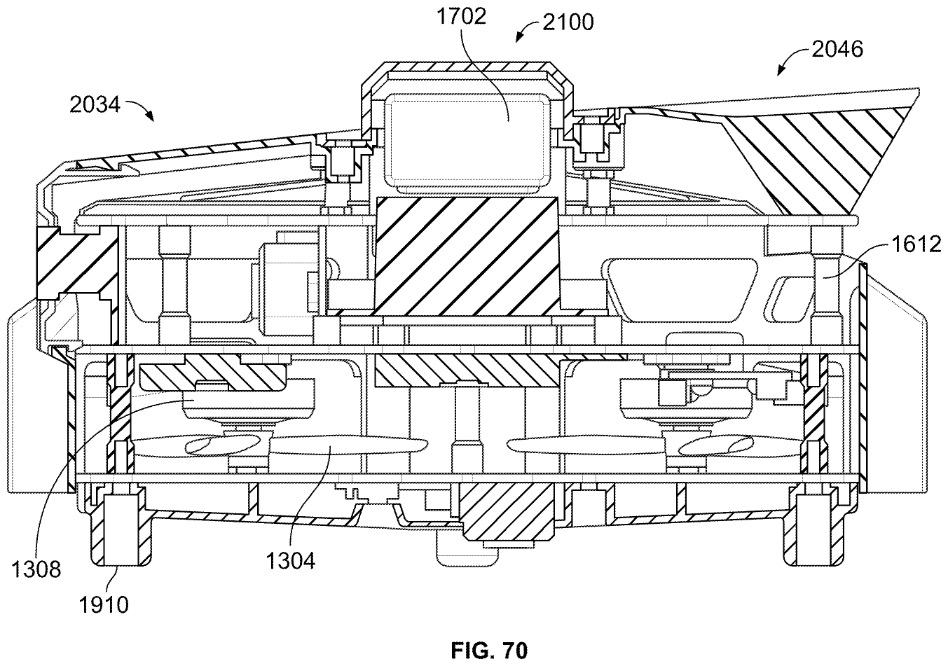

FIGS. 57-70 depict a drone housing 1800 to protect the drone. The housing 1800 includes a bottom housing 1900, top housing 2000, and top battery cover 2100. FIG. 57 depicts an exploded view of the drone housing 1800 with the drone 1100 depicted between the top and bottom housing 1900, 2000. In an embodiment, the drone housing 1800 is between approximately 100-250 mm in length from front 2006 to back 2008, between approximately 100-250 mm in length from side-to-side, and between approximately 50-150 mm from the bottom of the drone housing 1800 to the top of the drone housing 1800. In the preferred embodiment, the drone housing 1800 is approximately 187 mm in length from front 2006 to back 2008, approximately 187 mm in length from side-to-side, and approximately 110 mm from bottom face of the bottom housing 1918 to top side of the battery cover 2100.

### Bottom Housing

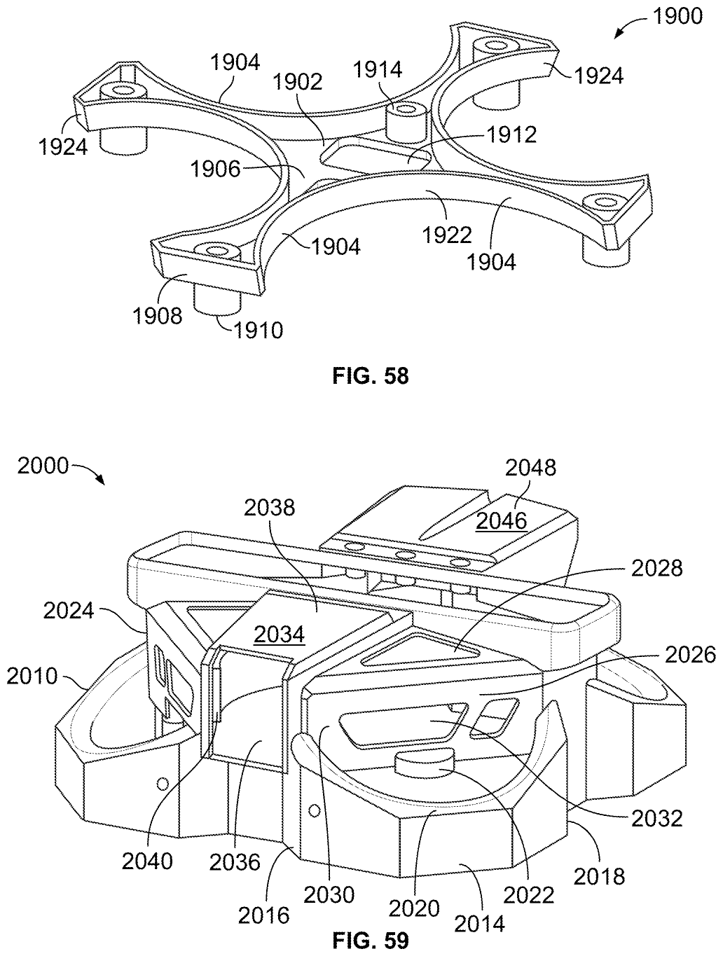

The bottom housing 1900 is generally depicted in FIG. 58 and provides protection for the drone's 1100 bottom side. The bottom housing 1900 has a bottom face 1918 and a top face 1920. The bottom face 1918 is positioned to face away from the drone body 1100 and the top face 1920 is positioned to interact with or affix to bottom frame 1202 of the propeller guard sub-assembly 1200.

In an embodiment, the bottom housing 1900 may connect to the sub-frame assembly 1200 using M3 (3 mm) titanium or 304 stainless steel bolts. In alternative embodiments, other fastening means are considered.

In an embodiment, the bottom housing 1900 further comprising four landing pads 1910 protruding from the bottom face 1918 of the bottom housing 1900.

The bottom housing 1900 further comprises a central hub 1902, a plurality of arms 1904 extending therefrom, an opening 1912 proximate the hub 1902, and a perimeter wall 1924 extending along the edge of the plurality of arms 1904 and hub 1902 to form a concave shape.

In the embodiment of FIG. 58, the central hub 1902 comprises an opening 1912. In an embodiment, a variety of devices may be placed within the opening 1912, including but not limited to a downward facing Lidar sensor, optical flow sensor and/or camera. Alternatively, the opening 1912 may provide a connection for any one of the firearm malfunction devices (including but not limited to the airbag actuator device 2800 and malfunction plate 2200, 2300, 2400, 2500, 2600, 2700) disclosed herein. In the preferred embodiment, lidar is placed within the opening 1912 to improve coordination of the drone.

In the embodiment of FIG. 58, a plurality of arms 1904 extend from the hub 1902. Each arm 1904 comprises a first end 1906, proximate the hub 1902 and a second end 1908, spaced apart from the hub 1902. In the preferred embodiment, a landing pad 1910 is attached to the second end of each arm 1904. The landing pads 1910 may be made from any material known in the art and can absorb the shock created by the drone's landing 1100.

In an embodiment, the space between each of the arms 1904 forms an arc 1922. The arcs 1922 substantially align with the arcs formed by the arms 1206 of the propeller guard sub-assembly 1200 and are shaped to avoid interference with the propellers 1300.

In an embodiment, the bottom housing 1900 may comprise a plurality of flow sensors 1914. The flow sensors 1914, also known as optical flow sensors provide a method of navigation and control of the drone 1100 when GPS is unavailable. A downward-facing optical sensor 1914 provides the flight controller 1502 with the means to sense movements in the horizontal plane and allows the drone 1100 to remain stationary (and/or prevent drift) during flight when positional information is unavailable from GPS.

In an embodiment, the space between the first arm end 1906 and the second arm end 1908, may comprise an arm support beam. The arm support beams provides stability to the shape and strength of the arms 1904. Specifically the arm support beams may comprise a small notch which connects the perimeter walling 1924 of both sides of an arm 1904 at the narrowest portion of the arm 1904. The arm support beams ensure that the arms 1904 retain their rigid shape.

The concave nature of the bottom housing 1900 lowers the total weight of the bottom housing 1900 thereby improving the operability of the drone 1100. In alternative embodiments, the bottom housing 1900 is comprised of a single, thick piece of material that does not include a concave body.

### Top Housing

The top housing 2000 is generally depicted in FIG. 59. The top housing 2000 has a bottom end 2002, a top end 2004, a front end 2006 and a back end 2008. The top housing 2000, battery cover 2100, and bottom housing 1900 combine to form a frame for the drone 1100.

In the embodiment of FIG. 59, the top housing 2000 comprises an air frame housing 2010, a motor housing 2022, and a flight controller housing 2024. The top housing 2000 protects the top side of the drone 1100 including, but not limited to, the internal components 1502, propellers 1300, and propeller motors 1306.

The top housing 2000 preferably allows airflow to the propeller motors 1306, internal components 1500 and modules, and does not inhibit the movement of the drone 1100. The top housing 2000 is capable of interacting with or connecting to the bottom housing 1900 and the battery cover 2100 to provide comprehensive protection for the drone and any equipment or sensors affixed thereto.

In the preferred embodiment, the air frame wall 2014 extends from the bottom end 2002 of the top housing 2000 and continues to the top end of the air frame housing 2020. The air frame housing 2010 further comprises air frame walls 2014 for each propeller and propeller motor 1300, 1306 of the drone 1100. Each air frame wall 2014 forms an arc between a first side of the air frame wall 2016 and a second side of the air frame wall 2018. The radius of the arc is larger than the length of the propellers 1300 to prevent interference with flight of the drone 1100.

In the preferred embodiment, the air frame wall 2014 protects the propellers 1300 while allowing air to flow through the drone body 1100 and drone housing 1800. The propellers 1300 are powered by a motor 1306, which is protected by the motor housing 2022. The air frame housing 2010 is connected to the flight controller housing 2024.

In the preferred embodiment, the flight controller housing 2024 comprises an air port 2026 for each air frame housing 2010. Each air port 2026 is positioned partially above each propeller 1300. Each air port 2026 comprises a top wall 2028 which is connected to a motor wall 2030. Each motor wall comprises air outlets 2032. The air outlets 2032 allow air to flow between the interior and exterior of the housing 1800 to cool the drone 1100 and its components.

In an embodiment, the flight controller housing 2024 further comprises a front fin 2034, a rear fin and a bottom battery cover 2056.

As shown in FIG. 59, the front fin 2034 further comprises a front opening 2036, a top wall 2038, and optionally, a connection means 2040, which can be used to connect a camera bevel or any other equipment or hardware 2062 to the drone. The front opening 2036 is preferably configured for a camera or other optical sensor to aid the drone 1100 in navigation to detect and approach a target, but can be configured to allow any type of equipment, hardware, or other sensor to be affixed to the drone 1100.

As depicted in FIG. 59, the front opening 2036 is substantially rectangular but may form any shape or configuration as may be necessary to allow a sensor or other equipment to observe the environment or detect a target. In the embodiment of FIG. 59, the front opening 2056 further comprises a connection means 2040. The connection means is preferably configured to receive a camera bevel 2062, but can be configured to receive any kind of hardware.

The front fin 2034 further comprises a first groove 2042 capable of receiving the battery cover 2100, and apertures 2044 to connect to the battery cover 2100.

As depicted in FIG. 59, opposite the front fin 2034 is a rear fin 2046. The rear fin 2046 is positioned proximate the back end 2008 of the top housing 2000 and further comprises a top wall 2048 and a rear opening 2050.

In an embodiment, the rear fin 2046 further comprises a second groove 2052 capable of receiving the top battery cover 3000 and second apertures to connect to the battery cover 2100.

The top wall 2048 is positioned on the top end of 2004 of the top housing 2000 and above the rear opening 2050. The rear opening 2050 is configured to allow air to flow into the motors of the drone 100.

In the embodiment of FIG. 59, the bottom battery cover 2056 is positioned between the rear top wall 2048 and the front top wall 2038 and is configured to receive the top battery cover 2100 together to substantially enclose the battery pack 1700 of the drone within the top battery cover 2100 and the bottom battery cover 2056.

The bottom battery cover 2056 has an outer wall 2058 portion and an inner ridge 2060 portion. The outer wall 2058 portion of the bottom battery cover 2056 aids in the protection of the battery from environmental elements which could damage or disrupt the battery while the inner ridge of the battery abuts the battery and prevents the battery from moving while the drone 100 is in use.

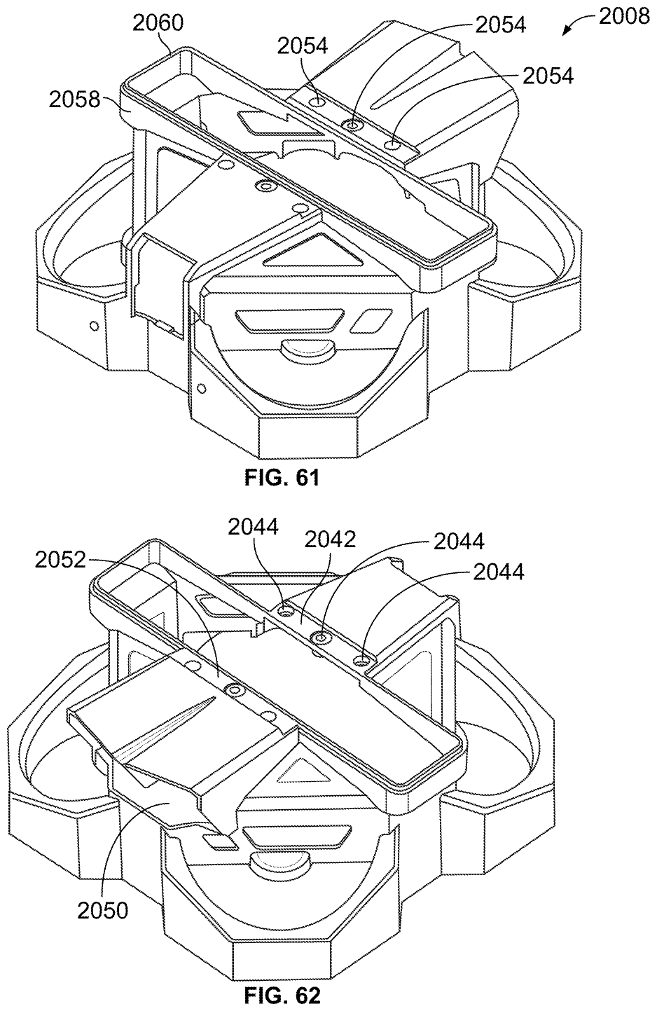

Additional view of the top drone housing 2000 are depicted in FIGS. 61-67.

### Battery Cover

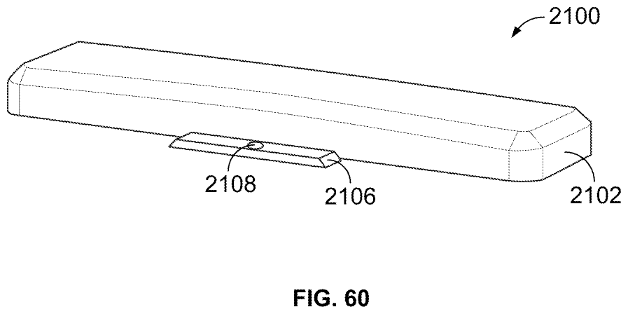

The battery cover 2100 and battery cover flange 3006 are depicted in FIG. 60. The battery cover 2100 comprises an outer wall 2102 and an inner wall (not depicted). The inner wall abuts the battery pack 1700 and ensures that the battery pack 1700 does not dramatically shift positions during operation of the drone 1100. The outer wall 2102 of the battery cover 2100 provides protection for the battery pack 1700 by preventing ingress of any environmental contaminants into the battery pack 1700.

The battery cover flange 2106 comprises at least one aperture 2108, and at least one fastener (not depicted). The battery cover 2100 is positioned above the top housing 2000 and is connected to the top housing 2000 by means of at least one fastener, which is inserted through at least one aperture 2108 in the battery cover flange 2106. The top battery cover 2100 can be connected to the top housing 2000 at the bottom battery cover 2056 site and by means of the first and second grooves 2042, 2052 in the top housing and the first and second apertures 2044, 2054 in the top housing 2000. The battery cover flange 2106 is connected to the battery cover 2100 along one side edge of the battery cover 2100 as depicted in FIG. 60.

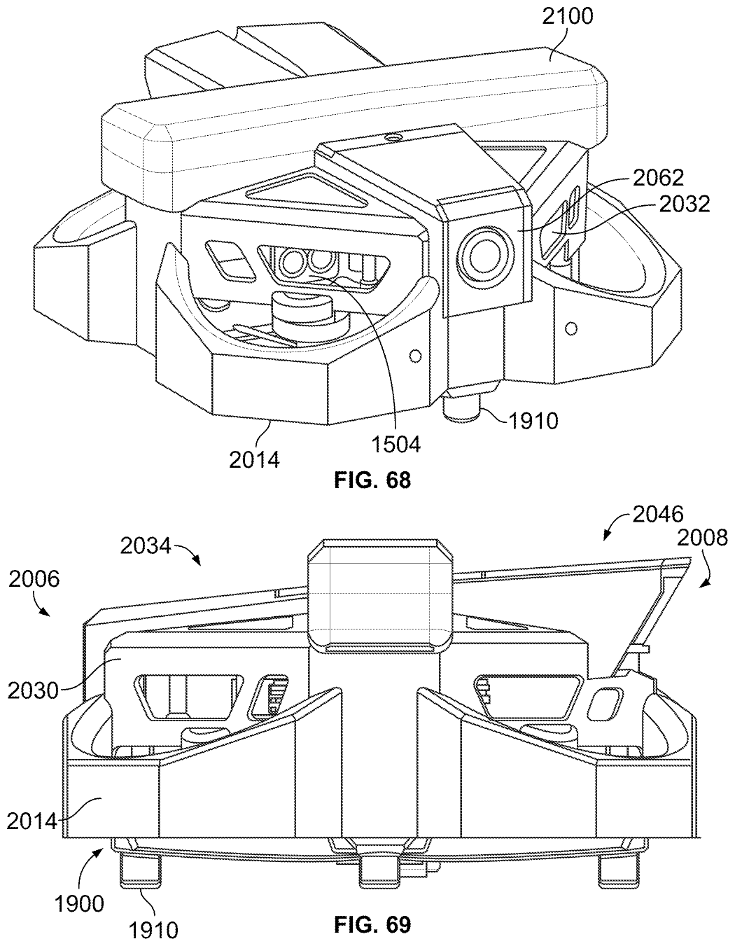

The drone fits within the void space created between the top housing 2000 and bottom housing 1900. FIGS. 68-70 depict the drone 1100 secured within the top housing 2000 and bottom housing 1900.

The top housing 2000 is secured to the top frame 1600 with four M3 (3 mm) titanium or 304 stainless steel bolts. In alternative embodiments, a plurality of alternative fastening devices may be used. The fastening devices may be applied through a plurality of apertures located proximate the battery cover 2100. Securing the top housing 2000 to the top frame 1600 prevents movement of the drone 1100 within the housing and protects internal components from unnecessary exposure.

### Air Bag Actuator

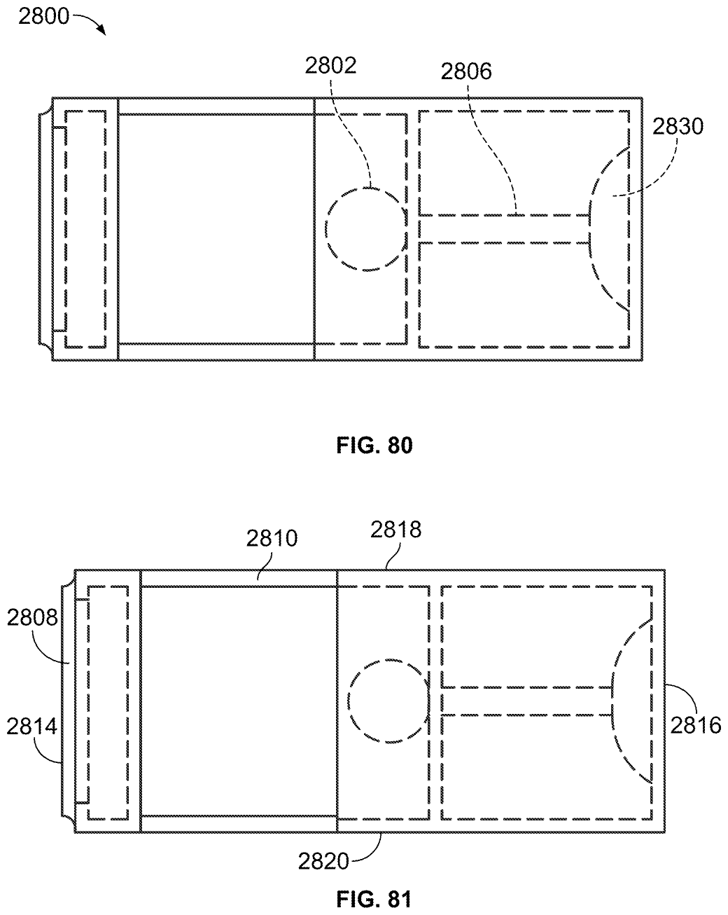

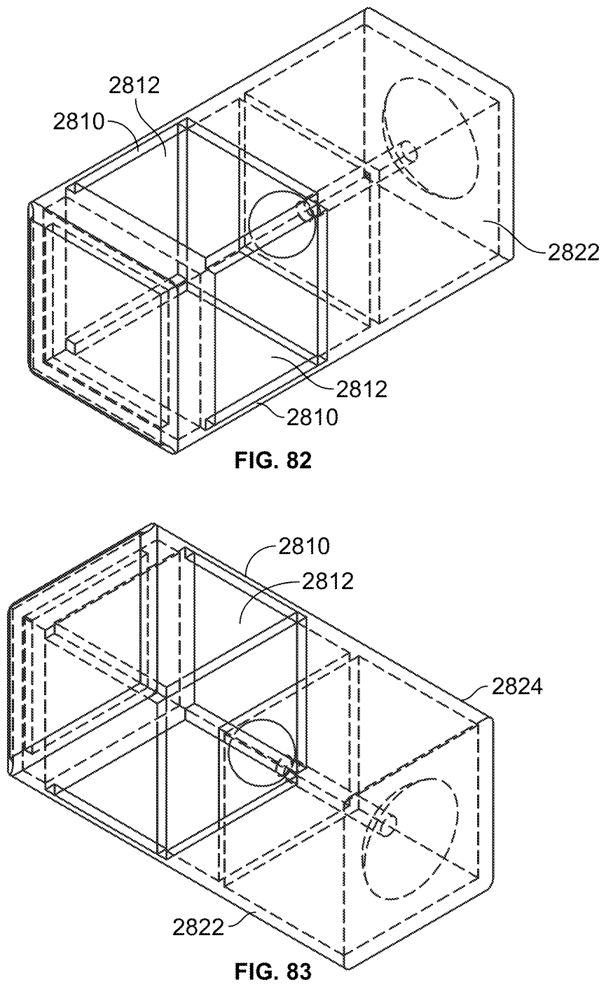

FIGS. 80-83 depict an air bag actuator system 2800. The air bag actuator system 2800 may be detachably mounted to the drone body or drone housing to assist in disarming or disabling a target, may be used as a separate device, or may be attached to any other device to disable or disarm a target. FIGS. 80-83 depict the air bag actuator system 2800 prior to engaging with a firearm or other target.

FIGS. 80-83 depict the air bag actuator system 2800 in solid and dashed lines. Dashed lines represent elements which would not be directly visible to an individual observing the system 2800.

The air bag system 2800 comprises an airbag 2802, electrical wiring 2806, a detonator 2804 attached to the airbag device, a magnet 2808, an accelerometer 2816, and a frame body 2810. In an embodiment the airbag 2802 is comprised of a material sufficiently light and difficult to puncture, including but not limited nylon, silk, wool, polyester, Kevlar, synthetic polymer, other suitable material, or a combination thereof. In an embodiment, the magnet 2808 is a three inch by three inch magnet 2808.

The frame body 2810 comprises a plurality of opening 2812, a front end 2814, a back end 2816, a top side 2818, a bottom side 2820, and a right and left side 2822, 2824.

In the embodiment depicted in FIGS. 80-83, an accelerometer 2830 is located within the air bag actuator system 2800. In the preferred embodiment, the accelerometer 2830 is located proximate the interior, back side 2816 of the air bag actuator 2800. In alternative embodiments, the accelerometer 2830 may be placed along any side of the air bag system 2800.

The accelerometer 2830 is operatively connected to a detonator 2804 which is attached to the airbag 2802. Electrical wiring 2806 forms the operative connection between the accelerometer 2830 and the detonator 2804. In FIGS. 80-83, the airbag 2802 is depicted in a furled configuration. In an embodiment the detonator 2804 is located within the furled configuration of the airbag 2802. In alternative embodiments, the airbag 2802 may be partially inflated.

In the embodiment depicted in FIG. 80-83, a magnet 2808 is attached to the exterior portion of the front end 2814 of the air bag actuator system 2800. The embodiment depicted in FIG. 80-83 includes a plurality of openings 2814 located along each of the top side 2818, bottom side 2820, right side 2822, and left side 2824. The plurality of openings 2814 are located proximate the front end 2814 of the air bag actuator system 2800.

The air bag actuator system 2800 may disarm or disable a target by preventing an armed target from accessing the firearm by enveloping the firearm.

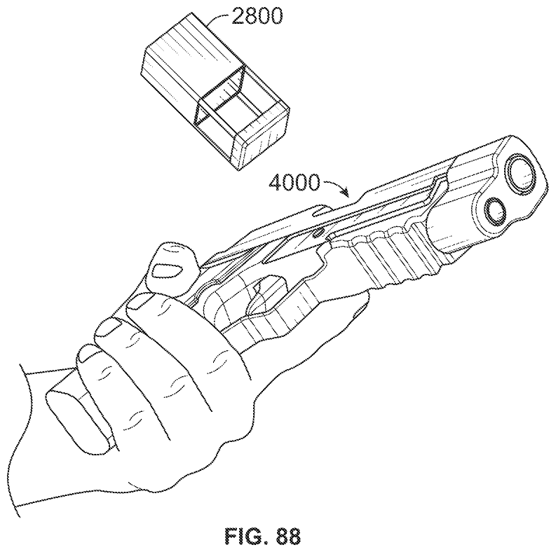

In an embodiment, the air bag actuator system 2800 is detachably connected to the drone 1100 and/or drone housing 1800. The drone 1100 detects and moves toward a target firearm. As the drone 1100 approaches the target firearm, the magnet 2808 provides an attractive force between the firearm and the air bag actuator system 2800. FIG. 88 depicts the air bag actuator device 2800 moving toward a firearm.

When the magnet 2808 makes contact with the firearm, the accelerometer 2830 senses a change in the drone's movement and triggers the detonator 2804 and deploys the airbag 2802. In the preferred embodiment, the accelerometer 2830 may detect any contact with a firearm (whether direct or glancing) and activate the detonator 2804 which deploys the airbag 2802. When the airbag 2802 is deployed, it unfurls and expands through the series of openings 2812 which allows the airbag 2802 to expand outward and envelop the firearm. The magnet 2808 may secure the front of the air bag actuator system 2800 to the firearm as the airbag 2802 envelops the firearm. As the airbag 2802 unfurls, the magnet 2808 may release or detach from the firearm or it may remain secured to the firearm. In the event of a glancing blow, the magnet 2808 may not remain secured to the firearm, however, the airbag 2802 will still deploy and envelop the firearm.

In an embodiment, the explosive force of the detonator 2804 guides the airbag 2802 in the direction of the firearm. In another embodiment, the unfurled shape of the airbag 2802 is crescent-like which assists the airbag 2802 in wrapping around a firearm. In another alternative embodiment, the exterior of the airbag 2802 may comprise an adhesive substance which assists with securing the airbag 2802 to the firearm. In another alternative embodiment, the airbag 2802 comprises an adhesive substance along the airbag surface as well as a plurality of magnets. In this alternative embodiment, the airbag 2802 applies a plurality of magnets to the ejection port of a firearm. In this alternative embodiment, the plurality of magnets enter the ejection port of the firearm 4000 to obstruct the slide of the firearm and disable the firearm. In alternative embodiments, the strength of the magnets interfere with the operability of the firearm, and prevent the slide from moving which effectively locks the firearm.

In another alternative embodiment the airbag 2802 may attach to any portion of the firearm and inflate to prevent the target from operating the firearm. In one example, the airbag 2802 may inflate around the grip and trigger of the firearm to prevent the target from accessing either the grip or trigger. In another example, the airbag 2802 may inflate around the slide, proximate the barrel of the firearm. In this example, the airbag 2802 may adhere to the firearm and prevent the slide from moving, effectively locking the firearm.

In the preferred embodiment, the airbag 2802 detaches from the air bag actuator frame 2010 as it is deployed.

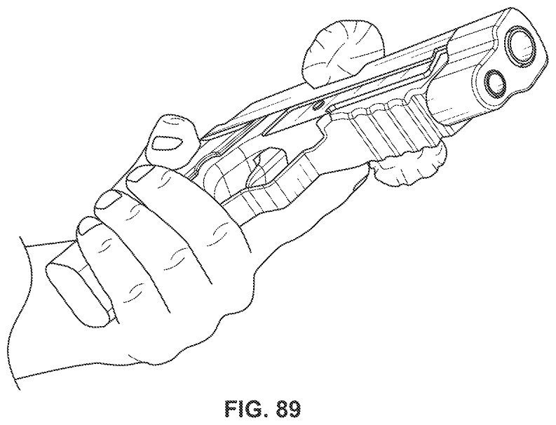

FIG. 89 depicts the airbag 2802 of the airbag actuator device 2800 in an expanded state around the ejection port of the firearm after the airbag actuator device 2800 contacts the firearm.

The airbag system 2800 is configured to be attached to any type of drone system, including the drones 100, 900, 1000, 1100 disclosed herein. Alternatively, the airbag system 2800 may be used with other weapon disabling devices.

### Malfunction Plate

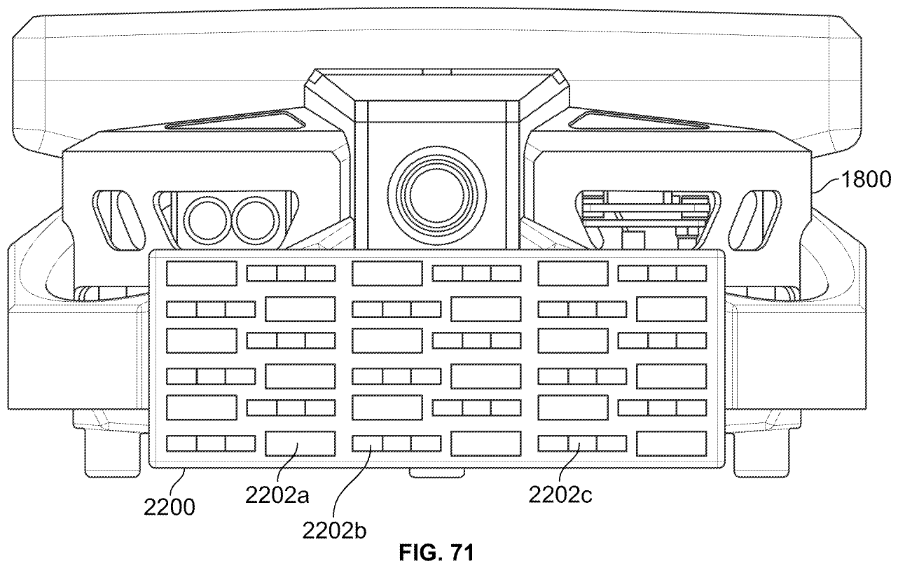

FIGS. 71-79 depict several embodiments of a malfunction plate 2200, 2300, 2400, 2500, 2600, 2700. The malfunction plate 2200, 2300, 2400, 2500, 2600, 2700 comprises a sheet of material which is configured to make contact with the ejection port 4000 of a firearm and release firearm malfunctioning material 2204, 2304, 2404, 2504, 2604, 2704 to disable the firearm. In an embodiment, the firearm malfunction plate 2200, 2300, 2400, 2500, 2600, 2700 may comprise a soft plastic, hard plastic, metal, composite, synthetic polymer, or other suitable material capable of striking a hard surface without breaking. The malfunction plate 2200, 2300, 2400, 2500, 2600, 2700 may comprise any number of shapes, such as any polygon or a circular shape. In the preferred embodiment, the malfunction plate 2200, 2300, 2400, 2500, 2600, 2700 comprises a rectangular shape having a first length of approximately 3.375 inches, a second length of approximately 2 inches, and a thickness of approximately 0.1875 inches. In an alternative embodiment, the malfunction plate 2200, 2300, 2400, 2500, 2600, 2700 comprises a rectangular shape having a first length of approximately 2-4 inches, a second length of approximately 1-3 inches, and a thickness of up to 1 inch.

### First Embodiment

FIG. 71 discloses a first embodiment of a malfunction plate 2200 detachably connected to the drone 1100 via the drone housing 1800. The first embodiment of the malfunction plate 2200 may be attached to any type of drone system, including the drones 100, 900, 100, 1100. Alternatively, the malfunction plate 2200 may be used with other weapon-disabling devices.

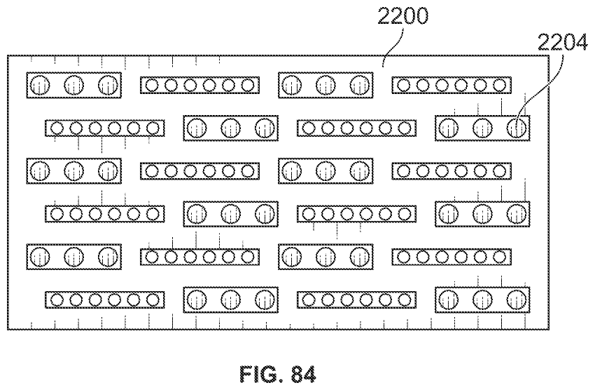

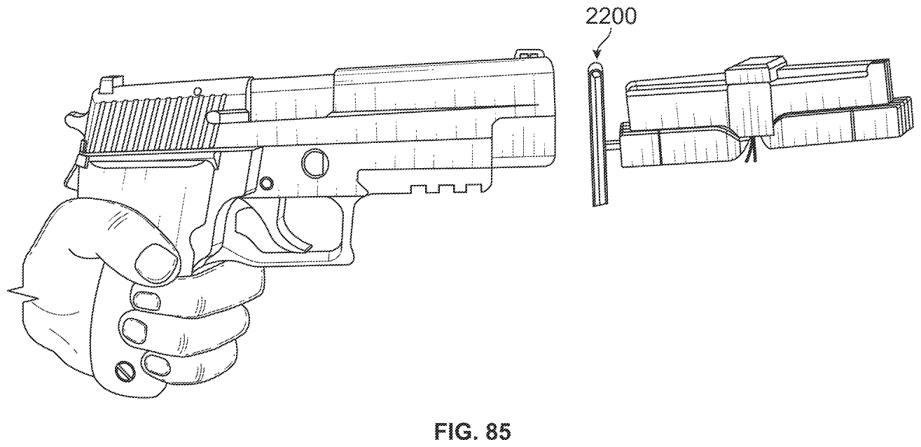

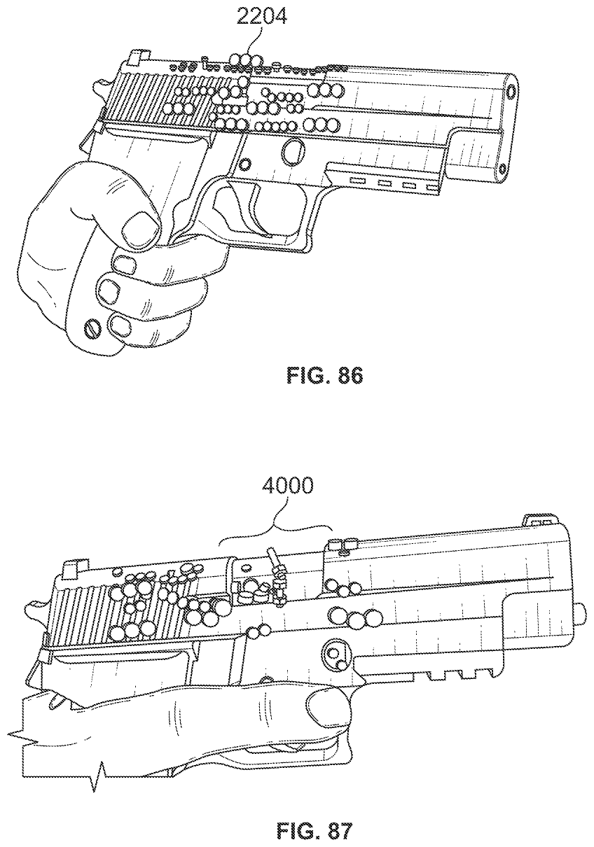

The malfunction plate 2200 may further comprise a series of channels 2202 capable of receiving firearm malfunctioning material 2204 (depicted in FIG. 84). In the preferred embodiment, the firearm malfunctioning material 2204 comprises a plurality of magnets. The magnets 2204 may be any magnet of considerable strength and suitable size and are preferably a rare earth magnet capable of interacting with a firearm as to render the firearm unusable by obstructing the firearm's cycle of operations through various means once applied. In other embodiments, other conveyable materials that may adhere to a firearm may be used in connection with the malfunction plate 2200. In an alternative embodiment, the firearm malfunctioning material may comprise metals, fabrics, mesh, glue, putty, gel, cotton, steel wool, rare earth metals, any similarly situated material, or a combination thereof.

The channels 2202 may comprise a plurality of sizes. As shown in FIG. 71, the malfunction plate 2200 comprises three channels of varying size 2202a, 2202b, 2202c. In the preferred embodiment, the channels 2202 are cut into the malfunction plate 2200 at varying intervals to optimize the variety and size of magnets 2204 that can be delivered to a target in a single payload. The three varying channel sizes 2202a, 2202b, 2202c may be arranged in any pattern or may alternate.

In an embodiment, the first-sized channel 2202a is capable of receiving magnets which are approximately five millimeters in diameter by three millimeters in depth. In alternative embodiments, other magnet sizes are considered.

In an embodiment the second-sized channel 2202b is capable of receiving magnets 2804 of a plurality of dimensions which are approximately three millimeters in diameter and one millimeter in depth. In alternative embodiments, other magnet sizes are considered. Within the second-sized channels 2202b, a third-sized channel 2202c is also disclosed. The third-sized channel 2202c is within the second-sized channel 2202b and is capable of receiving magnets approximately three millimeters in diameter×one millimeter deep.

In an embodiment, each channel 2202 comprises a strip of ferrous material (or similar material) sufficient to secure the firearm malfunctioning material 2204 within the channels 2202a, 2202b, 2202c until the malfunction plate 2200 is proximate (or makes contact with a firearm). In an embodiment, the strip of ferrous material is placed along the bottom surface of the channel 2202a, 2202b, 2202c.

To limit unwanted electromagnetic interference from the magnets on other components of the drone 1100, electromagnetic-shielding tape or other similar electromagnetic-shielding material may be affixed to the rear side of the malfunction plate 2200. This embodiment is preferable because it allows several magnet sizes 2204 and types to be delivered in a payload thereby increasing the effectiveness of the drone system to disrupt or disable a variety of firearms.

In the preferred method of use of the first embodiment of the malfunction plate 2200, the malfunction plate 2200 is secured to the front of a drone (or alternatively, the drone housing 1800 described herein). The drone, with the malfunction plate 2200 secured, detects a firearm and navigates toward the firearm. The drone strikes the firearm with the malfunction plate 2200 (preferably at the firearm's ejection port 4000). The contact between the malfunction plate 2200 and the firearm (as well as the magnetic forces between the magnets 2204 and the firearm) pull the magnets 2204 from the channels 2202a, 2202b, 2202c. The magnets 2204 secure themselves to the firearm (preferably at the firearm's ejection port 4000. The magnets 2204 interfere with and disable the operation of the firearm.

In the preferred embodiment, a plurality of magnets 2204 enter the ejection port of the firearm and obstruct the slide of the firearm. In alternative embodiments, the strength of the magnets 2204 interfere with the operability of the firearm, and prevent the slide from moving which effectively locks the firearm.

In alternative embodiments, the firearm malfunctioning material 2204 may comprise metals, fabrics, mesh, glue, putty, gel, cotton, steel wool, rare earth metals, any similarly situated material, or a combination thereof. In an alternative embodiment, the malfunction plate 2200 may be used in connection with the method of operating the drone disclosed herein.

### Second Embodiment

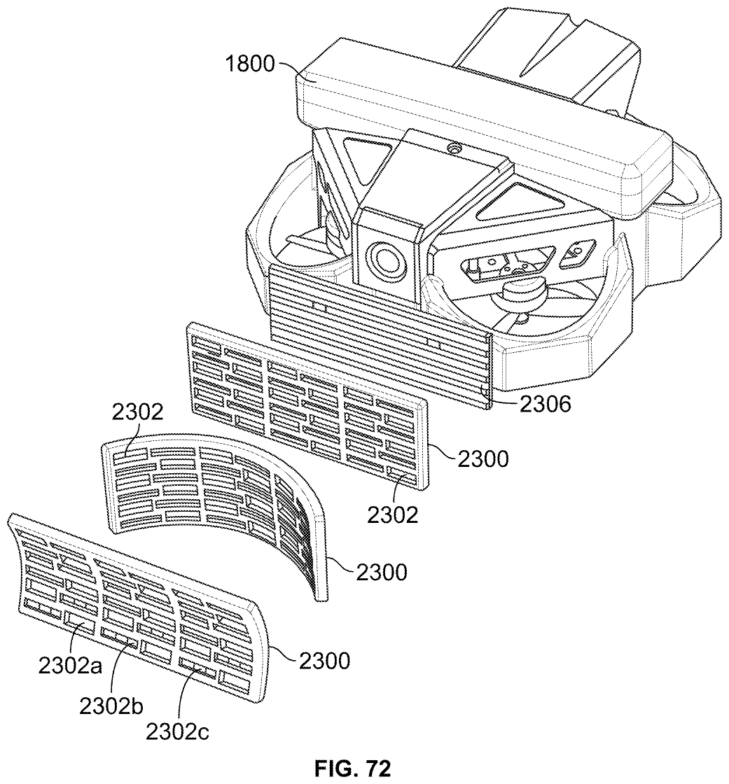

FIG. 72 depicts a second embodiment of the malfunction plate 2300 detachably connected to the drone 1100 and drone housing 1800. The second embodiment of the malfunction plate 2300 may be attached to any type of drone system, including the drones 100, 900, 100, 1100. Alternatively, the malfunction plate 2300 may be used with other weapon-disabling devices. Unless otherwise described, the second embodiment of the malfunction plate 2300 is substantially similar to the first embodiment of the malfunction plate 2200. Similarly labeled elements describe like elements between the first and second embodiments (i.e., 2202 and 2302 each refer to a plurality of channels).

In the second embodiment, the malfunction plate 2300 is a flexible plate made out of lightweight material and comprising alternative-sized channels 2302a, 2302b, 2302c cut into the plate 2300. The alternative-sized channels 2302 are substantially similar to the channels 2202 described above. However, these channels 2302 may take any size and shape capable of storing malfunctioning materials 2304.

In an embodiment, the first channel 2302a is approximately 5.4 millimeters by 15.4 millimeters and three millimeters in depth. In an embodiment, the second channel 2302b is approximately 3.4 millimeters by 19.2 millimeters and one millimeter in depth. In an embodiment, the third channel 2302c is located within the second channel 2302b and is approximately 6.4 millimeters and one millimeter deep. The channels are loaded with a plurality of malfunctioning materials (such as magnets 2304).

In the preferred method of using the malfunction plate 2300, the channels 2302 are loaded with a plurality of magnets 2304. In the preferred embodiment, the first channel 2302a is loaded with a plurality of three millimeter by five millimeter magnets 2304, the second channel 2302b is loaded with a plurality of one millimeter by three millimeter magnets, and the third channel 2302c is loaded with a plurality of two millimeter by three millimeter magnets.

As depicted in FIG. 72, the flexible malfunction plate 2300 may be detachably connected to a thin rigid plate 2306 that is connected to the drone's top housing 2000. The thin rigid plate 2306 comprises steel strips, which provide a strong attraction to the loaded malfunction plate 2300. The rear portion of the thin rigid plate 2306 may be coated with a layer of EMI-shielding tape or a substance of similar properties in order to protect the components of the UAV from any electromagnetic interference that may be caused by the loaded flexible malfunction plate 2300.

Unless otherwise disclosed below, the second embodiment of the malfunction plate 2300 operates in the same manner as the first embodiment of the malfunction plate 2200.

In the preferred method of use of the second embodiment of the malfunction plate 2300, a thin rigid plate 2306 is secured to the front of a drone (or alternatively, the drone housing 1800 described herein). A flexible malfunction plate 2300 is loaded with malfunctioning material 2304 and detachably connected to the thin rigid plate 2306. The drone, with the malfunction plate 2300 secured, detects a firearm and navigates toward the firearm. The drone strikes the firearm with the malfunction plate 2300 (preferably at the firearm's ejection port 4000). The contact between the malfunction plate 2300 and the firearm (as well as the magnetic forces between the magnets 2304 and the firearm) pulls the magnets 2304 and, in turn, the flexible malfunction plate 2300 away from the thin rigid plate 2306. As the magnets 2304 are pulled from their respective channels 2202a, 2202b, 2202c, the magnets 2304 distort the shape of the flexible malfunction plate 2300. The magnets 2304 secure themselves to the firearm (preferably at the firearm's ejection port 4000) and interfere with and disable the operation of the firearm. In the preferred embodiment, the flexible mounting plate 2300 detaches from the thin rigid plate 2306 as the magnets 2304 secure themselves to the firearm.

In the preferred embodiment, a plurality of magnets 2204 enter the ejection port of the firearm and obstruct the slide of the firearm. In alternative embodiments, the strength of the magnets 2204 interfere with the operability of the firearm, and prevent the slide from moving which effectively locks the firearm.

In an alternative embodiment, the firearm malfunctioning material 2204 may comprise metals, fabrics, mesh, glue, putty, gel, cotton, steel wool, rare earth metals, any similarly situated material, or a combination thereof instead of magnets 2204. In an alternative embodiment, the malfunction plate 2200 may be used in connection with the method of operating the drone disclosed herein.

The design of flexible plate 2300 assists with even distribution of the magnets 2204 around the contours of the target firearm. In an embodiment, the flexible plate 2300 may be secured to the firearm. In this embodiment, the ferrous strip within the channels 2302a, 2302b, 2302c, magnets 2204, and firearm ejection port 4000 are fastened together via magnetic forces. In an alternative embodiment, the flexible plate 2300 does not secure itself to the firearm. In this embodiment, the magnets 2204 entirely separate themselves from the ferrous strip within the channels 2302a, 2302b, 2302c and adhere solely to the firearm ejection port 4000.

### Third Embodiment

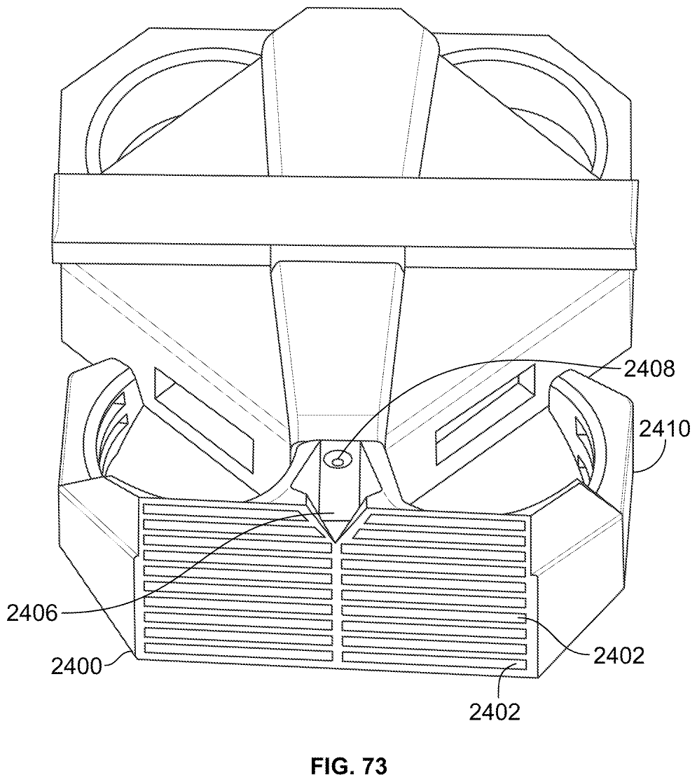

FIG. 73 depicts a third embodiment of the malfunction plate 2400 detachably connected to a drone. The second embodiment of the malfunction plate 2400 may be attached to any type of drone system, including the drones 100, 900, 100, 1100 or drone housing 1800. Alternatively, the malfunction plate 2400 may be used with other weapon-disabling devices. Unless otherwise described, the third embodiment of the malfunction plate 2400 is substantially similar to the first and second embodiments of the malfunction plates 2200, 2300. Similarly labeled elements describe like elements between the first and second embodiments.

FIG. 73 shows a malfunction plate 2400 with a cut out portion 2406 to allow a camera and/or other sensors to view through the top of the plate 2400. In this embodiment, the malfunction plate 2400 comprises a series of channels 2402 having a strip ferrous or other similar material sufficient to secure firearm malfunctioning material 2204.

Electromagnetic-shielding material is incorporated into the front plate 2400 in this embodiment.

As depicted in FIG. 73, the malfunction plate 2400 comprises a plurality of arms 2410 which comprise an air frame housing to protect drone propellers. The malfunction plate 2400 further comprises an aperture 2408 to fasten the malfunction plate 2400 to a drone device.

Unless otherwise disclosed below, the third embodiment of the malfunction plate 2400 operates in the same manner as the first embodiment of the malfunction plate 2200.

In the preferred method of use of the third embodiment of the malfunction plate 2400, the malfunctioning plate 2400 is secured to the front of a drone body or drone housing. The malfunction plate 2400 is loaded with malfunctioning material 2400, detects a firearm and navigates toward the firearm. The drone strikes the firearm with the malfunction plate 2400 (preferably at the firearm's ejection port).

The contact between the malfunction plate 2400 and the firearm (as well as the magnetic forces between the magnets 2204 and the firearm) pull the magnets 2204 from the channels 2402 and towards the firearm. The magnets 2204 secure themselves to the firearm (preferably at the firearm's ejection port 4000). The magnets 2204 interfere with and disable the operation of the firearm.

In the preferred embodiment, a plurality of magnets 2204 enter the ejection port of the firearm and obstruct the slide of the firearm. In alternative embodiments, the strength of the magnets 2204 interfere with the operability of the firearm, and prevent the slide from moving which effectively locks the firearm.

In an alternative embodiment, the firearm malfunctioning material 2204 may comprise metals, fabrics, mesh, glue, putty, gel, cotton, steel wool, rare earth metals, any similarly situated material, or a combination thereof. In an alternative embodiment, the malfunction plate 2400 may be used in connection with the method of operating the drone disclosed herein.

### Fourth Embodiment

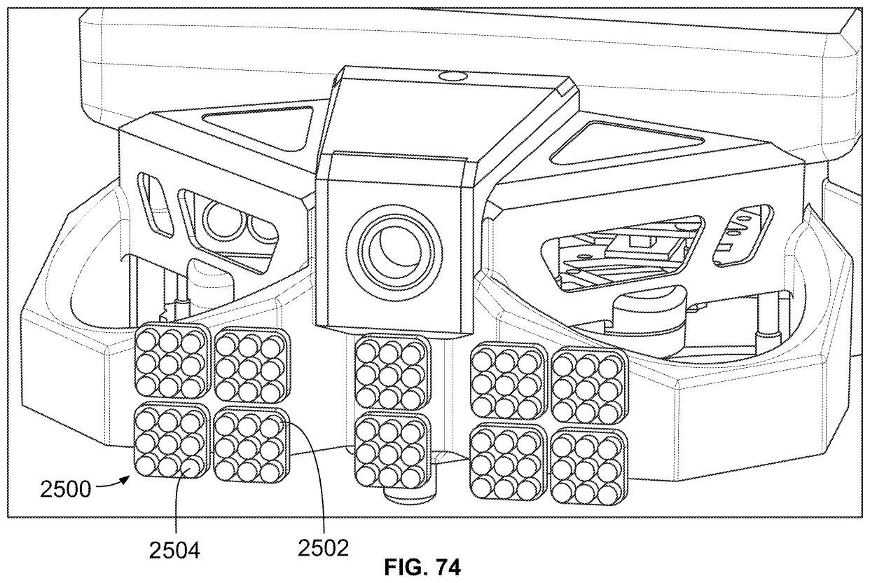

FIG. 74 depicts a fourth embodiment of the malfunction plate 2500 detachably connected to the drone 1100 and drone housing 1800. The fourth embodiment of the malfunction plate 2500 may be attached to any type of drone system, including the drones 100, 900, 100, 1100. Alternatively, the malfunction plate 2500 may be used with other weapon-disabling devices.

FIG. 74 depicts a malfunction plate 2500 which is comprised of several individual plates, each comprising a plurality of magnets 2204. The individual plates are detachably connected to the front of the drone housing 1800. Each of the plurality of magnets 2504 is positioned in an individually sized magnet channel 2502. The magnets 2204 are secured to the magnet channel 2502 by a ferrous strip of material which lines each magnet channel 2502.

In an embodiment, each individual plate of the malfunction plate 2500 is substantially square and is approximately 18 millimeters by 18 millimeters and may be connected to the drone body by means of a mount. The mounts may be substantially rigid or semi flexible. The back side of each mount is preferably coated in an electromagnetic-shielding material.

Unless otherwise disclosed below, the fourth embodiment of the malfunction plate 2500 operates in the same manner as the first embodiment of the malfunction plate 2200.

In the preferred method of use of the fourth embodiment of the malfunction plate 2500, the malfunctioning plate 2500 is secured to the front of a drone (or alternatively, the drone housing 1800 described herein). The malfunction plate 2500 is loaded with malfunctioning material 2500, detects a firearm and navigates toward the firearm. The drone strikes the firearm with the malfunction plate 2500 (preferably at the firearm's ejection port).

The contact between the malfunction plate 2500 and the firearm (as well as the magnetic forces between the magnets 2504 and the firearm) pull the magnets 2504 from the channels 2502 and towards the firearm. The magnets 2504 secure themselves to the firearm (preferably at the firearm's ejection port 4000). The magnets 2504 interfere with and disable the operation of the firearm.

In the preferred embodiment, a plurality of magnets 2504 enter the ejection port of the firearm and obstruct the slide of the firearm. In alternative embodiments, the strength of the magnets 2504 interfere with the operability of the firearm, and prevent the slide from moving which effectively locks the firearm.

In an alternative embodiment, the firearm malfunctioning material 2504 may comprise metals, fabrics, mesh, glue, putty, gel, cotton, steel wool, rare earth metals, any similarly situated material, or a combination thereof. In an alternative embodiment, the malfunction plate 2500 may be used in connection with the method of operating the drone disclosed herein.

### Fifth Embodiment

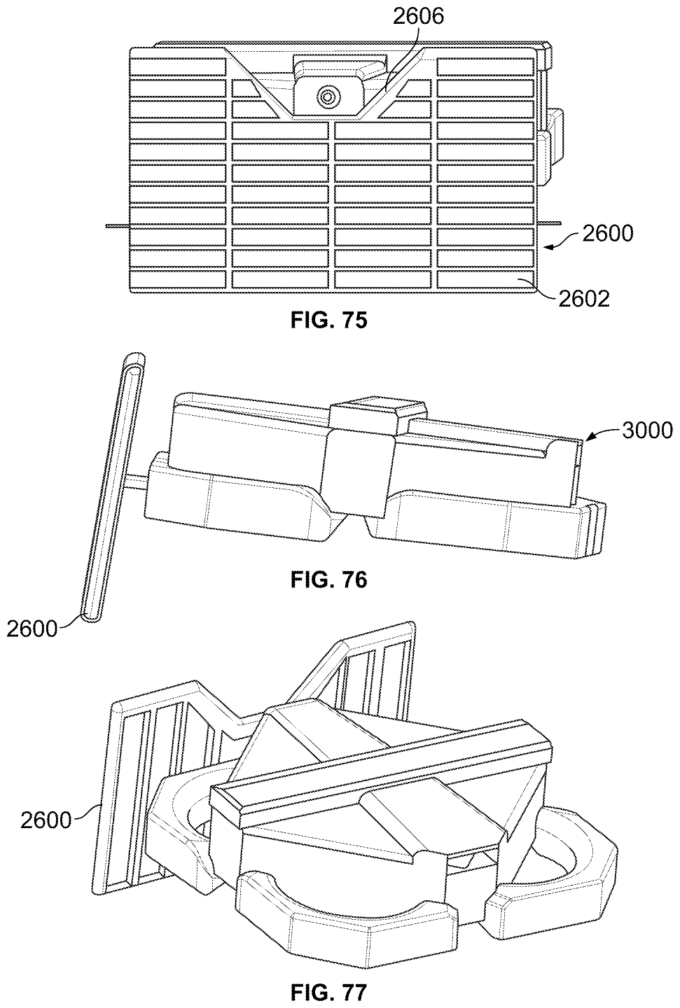

FIGS. 75-77 depict a fifth embodiment of the malfunction plate 2600 detachably connected to a drone. The fifth embodiment of the malfunction plate 2600 may be attached to any type of drone system 3000, including the drones disclosed herein 100, 900, 1000, 1100 or drone housing 1800. Alternatively, the malfunction plate 2600 may be used with other weapon-disabling devices. Unless otherwise described, the fifth embodiment of the malfunction plate 2600 is substantially similar to the first, second, and third embodiments of the malfunction plates 2200, 2300, 2400. Similarly labeled elements describe like elements between the first and fifth embodiments.

FIGS. 75-77 show a malfunction plate 2600 with a cut out portion 2606 to allow a camera and/or other sensors to view through the top of the plate 2600. In this embodiment, the malfunction plate 2600 comprises a series of channels 2602 having a strip of ferrous or other similar material sufficient to secure a malfunctioning material, such as a plurality of magnets 2204 to the series of channels 2602.

Once the malfunction plate 2600 is proximate (or makes contact with) a firearm, the attractive force of the magnets 2204 pulls the magnets 2204 from the channels 2202 and the magnets 2204 attach themselves to the firearm.

Electromagnetic-shielding material may be incorporated into the front plate 2600 in this embodiment.

Unless otherwise disclosed below, the fifth embodiment of the malfunction plate 2600 operates in the same manner as the first embodiment of the malfunction plate 2200.

In the preferred method of use of the fifth embodiment of the malfunction plate 2600, the malfunctioning plate 2600 is secured to the front of a drone (or alternatively, the drone housing 1800 described herein). The malfunction plate 2600 is loaded with malfunctioning material 2600, detects a firearm and navigates toward the firearm. The drone strikes the firearm with the malfunction plate 2600 (preferably at the firearm's ejection port).

The contact between the malfunction plate 2600 and the firearm (as well as the magnetic forces between the magnets 2204 and the firearm) pull the magnets 2204 from the channels 2202 and towards the firearm. The magnets 2204 secure themselves to the firearm (preferably at the firearm's ejection port 4000). The magnets 2204 interfere with and disable the operation of the firearm.

In the preferred embodiment, a plurality of magnets 2204 enter the ejection port of the firearm and obstruct the slide of the firearm. In alternative embodiments, the strength of the magnets 2204 interfere with the operability of the firearm, and prevent the slide from moving which effectively locks the firearm.

In an alternative embodiment, the firearm malfunctioning material 2204 may comprise metals, fabrics, mesh, glue, putty, gel, cotton, steel wool, rare earth metals, any similarly situated material, or a combination thereof. In an alternative embodiment, the malfunction plate 2600 may be used in connection with the method of operating the drone disclosed herein.

### Sixth Embodiment

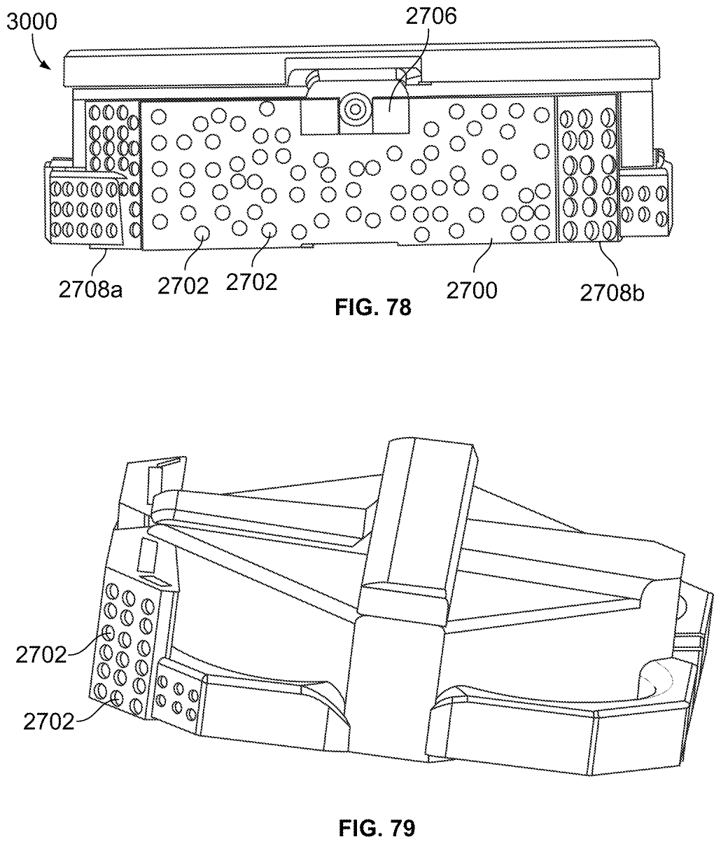

FIGS. 78-79 depict a sixth embodiment of the malfunction plate 2700. In this embodiment, the malfunction plate is integral with the front of any drone system 3000 (including the drones disclosed herein 100, 900, 1000, 1100 or drone housing 1800).

The malfunction plate 2700 comprises a flat front having a cutaway portion 2706 to allow a camera and/or other sensors to view through the top of the plate 2700. In addition, the malfunction plate 2708 comprises edge panels which partially wrap around the propellers of the drone 3000. The malfunction plate 2700 comprises a plurality of channels 2702 along its surface and edge panels 2708.

The plurality of channels each comprise a strip of ferrous or other material to secure a malfunctioning material, such as a plurality of magnets 2204 to the series of channels 2702.

Once the malfunction plate 2700 is proximate (or makes contact with) a firearm, the attractive force of the magnets 2204 pulls the magnets 2204 from the channels 2702 and the magnets 2204 attach themselves to the firearm.

Electromagnetic-shielding material may be incorporated into the front plate 2700 in this embodiment.

Unless otherwise disclosed below, the sixth embodiment of the malfunction plate 2700 operates in the same manner as the first embodiment of the malfunction plate 2200.

In the preferred method of use of the sixth embodiment of the malfunction plate 2700, the malfunctioning plate 2700 is integral with the front of a drone (or alternatively, the front of the drone housing 1800 described herein). The malfunction plate 2700 is loaded with malfunctioning material 2700, detects a firearm and navigates toward the firearm. The drone strikes the firearm with the malfunction plate 2700 (preferably at the firearm's ejection port).

The contact between the malfunction plate 2700 and the firearm (as well as the magnetic forces between the magnets 2504 and the firearm) pull the magnets 2204 from the channels 2702 and towards the firearm. The magnets 2204 secure themselves to the firearm (preferably at the firearm's ejection port 4000). The magnets 2204 interfere with and disable the operation of the firearm.

In the preferred embodiment, a plurality of magnets 2204 enter the ejection port of the firearm and obstruct the slide of the firearm. In alternative embodiments, the strength of the magnets 2204 interfere with the operability of the firearm, and prevent the slide from moving which effectively locks the firearm.

In an alternative embodiment, the firearm malfunctioning material 2204 may comprise metals, fabrics, mesh, glue, putty, gel, cotton, steel wool, rare earth metals, any similarly situated material, or a combination thereof. In an alternative embodiment, the malfunction plate 2700 may be used in connection with the method of operating the drone disclosed herein.

### Combination of Devices

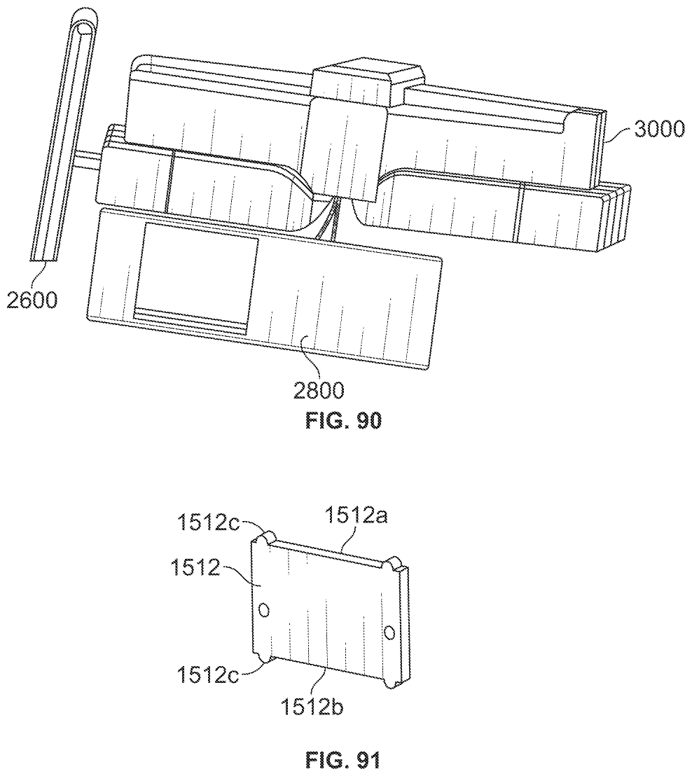

FIG. 90 depicts both of the airbag system 2800 and malfunction plate 2600 attached to any drone device 3000 (which may include the drones disclosed herein 100, 900, 1000, 1100 or drone housing 1800).

### Method of Use

In one method of disabling a firearm, the drone 100, 900, 1000, 1100 is launched from a drone platform and is directed toward a high threat target whom is carrying a weapon or firearm. The drone 100, 900, 1000, 1100 engages the target and interferes with the activities of the high-threat target. In an embodiment, the drone 100, 900, 1000, 1100 is attached within the drone housing 1800.

The drone housing 1800 provides a protective layer as well as cooling system for the drone 100, 900, 1000, 1100 to prevent the drone from overheating. The cooling system allows the drone to continue its flight for longer periods of time.

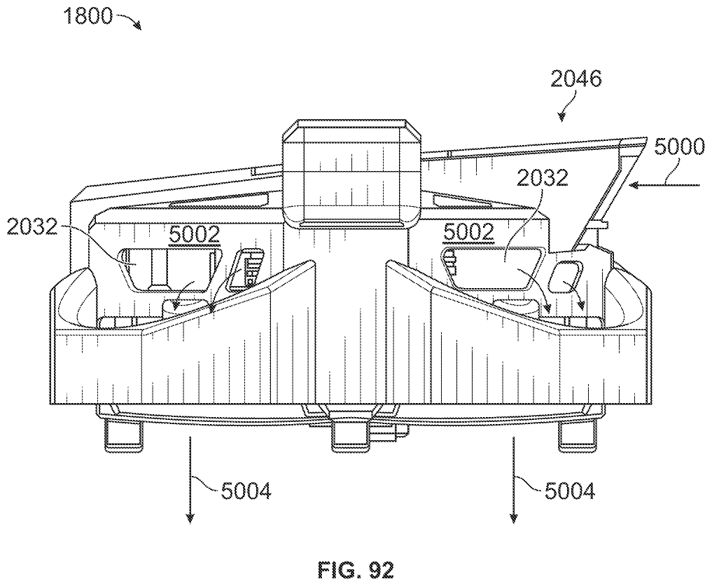

As depicted in FIG. 92, the shape of the drone housing 1800 provides a channel for ambient air to pass through the drone housing 1800 and cool the internal components of the drone 1100. Specifically, the rear opening 2050 of the drone housing draws ambient air into the drone 5000. The ambient air is directed through a plurality of air outlets 2032 and toward the plurality of propeller motors 5002. Finally, the ambient air is driven through the air frame openings 2012 and away from the drone 5004.

While the propellers are in operation, the propellers continuously draw ambient air through the rear opening 2050 of the drone housing 5000. As the ambient air passes through the drone housing 1800, it cools the internal drone components 1500.

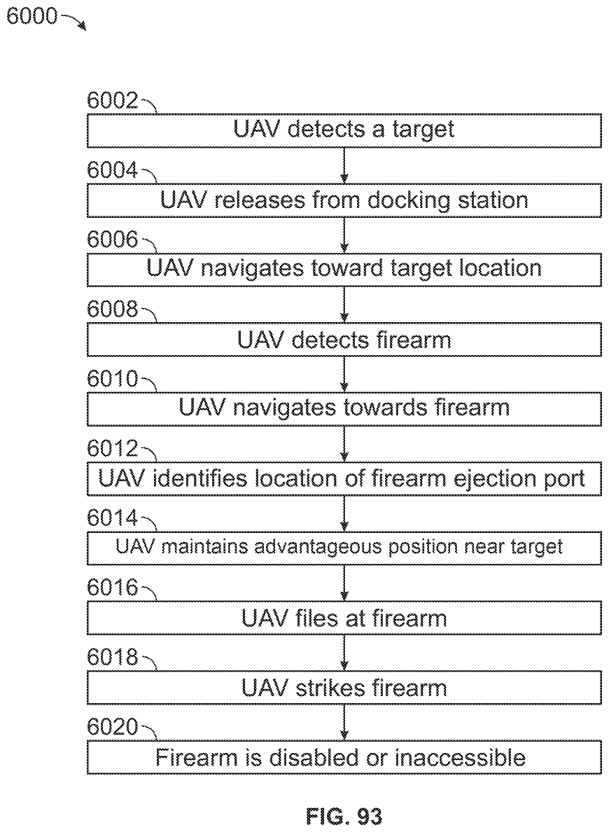

FIG. 93 depicts a flow diagram regarding one method of disabling a firearm using a drone 6000. This method of disabling a firearm 6000 may be used in connection with any drone device (preferably with one of the drones 100, 900, 1000, 1100, 1800 disclosed herein).

As the first step, the drone (also known as a UAV) detects a target 6002. In an embodiment, the drone is at rest in a docking station hidden from public view until the drone detects the target 6002. In an embodiment, the docking station charges the drone while the drone is at rest on the docking station. The drone may detect a target 6002 through means including but not limited to lidar, cameras, and software.

Next, the drone releases from the docking station 6004 and navigates toward the location of the target 6006. Next, the drone detects a firearm or other weapon in the possession of the target 6008 and navigates toward the firearm (or weapon). As the drone navigates toward the firearm it identifies the location of the firearm ejection port (as applicable) 6012.

The drone hovers above the target and prepares to approach the firearm (or weapon) 6014. As the drone circles the target, it does so in an irregular pattern to avoid capture or disablement. Next, the drone flies at the firearm 6016 and strikes the firearm 6018. In an embodiment, the firearm is stuck with sufficient force to knock the firearm out of the target's grasp. In another embodiment, the drone strikes the firearm with sufficient force to apply one of the malfunctioning devices (such as the malfunction plate 2200, 2300, 2400, 2500, 2600 and air bag actuator 2800 described herein). In the preferred embodiment, after the drone strikes the firearm, the firearm is disabled 6020. After the firearm is disabled, the drone may return to its docking station and recharge. In alternative embodiments, the firearm may still operable after it is struck by the drone. In the instance that the firearm is still operable, the drone once again begins circling above the target and firearm 6014 and repeats the steps of flying toward and striking the firearm 6016, 6018 until the firearm is disabled 6020.

Additionally the method of disabling a firearm using a drone 6000 may incorporate the steps describing the uses of any firearm malfunction devices described herein (including, but not limited to the malfunctioning plate 2200, 2300, 2400, 2500, 2600, 2700 and the air bag actuator 2800 disclosed herein).

In an alternative embodiment, the drone hovers proximate the target and emits a high pitch frequency to distract the target. In this alternative embodiment, the drone circles the target in an irregular pattern to avoid capture or disablement.

After interacting with the target and disabling the firearm, the drone withdraws from the immediate proximity of the firearm and target. The drone may return to the drone platform or continue to monitor the target. If the drone determines that the firearm remains operable, the drone may once again attempt to interfere with the operation of the firearm.

In an embodiment, the drone may be used in any environment, whether indoor or outdoor. The drone may be used to disable, disarm, and/or interfere with a target's firearm or weapon.

It is understood that the preceding is merely a detailed description of some examples and embodiments of the present invention and that numerous changes to the disclosed embodiments may be made in accordance with the disclosure made herein without departing from the spirit or scope of the invention. The preceding description, therefore, is not meant to limit the scope of the invention, but to provide sufficient disclosure to allow one of ordinary skill in the art to practice the invention without undue burden.

1. A drone comprising:
a bottom frame;
a plurality of bottom propeller frames detachably connected to the bottom frame;
a plurality of propellers and propeller motors;
a central frame, wherein the central frame is detachably connected to the bottom frame and the plurality propeller motors; and
a top frame, wherein the top frame is detachably connected to the central frame.

2. The drone of claim 1 further comprising a battery pack system detachably connected to the top frame of the drone, wherein the battery pack system comprises:
a first battery;
a second battery;
a first plate channel to fasten the first battery to the top frame, the first plate channel comprising a plurality of passthrough portions; and
a second plate channel to fasten the second battery to the top frame, the second plate channel comprising a plurality of passthrough portions;
wherein, the first and second plate channels wedged between the top frame and the first and second batteries and the plurality of passthrough channels in the first and second plate channels form airflow channels for heat to escape from the first and second batteries

3. The drone of claim 1 further comprising a drone housing, wherein the drone housing comprises:
a bottom housing, the bottom housing comprising a top face, a bottom face, a plurality of arms, and a perimeter wall;
a top housing, the top housing comprising, a front side, a back side, a bottom end, a top end, and a perimeter wall extending between the top end and bottom end, wherein the perimeter wall comprises:
a plurality of air frame openings to house the plurality of propellers and propeller motors,
a plurality of air ports positioned over the propeller motors, and
a plurality of air outlets forming channels for air to flow through the drone,
a rear fin extending from the back side of the top housing comprising a top wall and a rear opening to allow access to the drone;
a bottom battery pack system cover extending from the top housing; and
a top battery pack system cover detachably connected to the bottom battery pack system cover.

4. The drone of claim 3 wherein, the rear opening forms an entry channel for airflow into the body of the drone housing, the plurality of air outlets form an exit channel for airflow out of the body of the drone housing, and the plurality of air frame openings provide a passage for airflow to escape from proximity of the drone.

5. The drone of claim 1 further comprising a firearm malfunction device attachment to interfere with a firearm.

6. The drone of claim 5 wherein the firearm malfunction device attachment is selected from a group consisting essentially of a bistable band, an inflatable device, a harpoon, a net, a claw, a malfunction plate, and an airbag actuator system.

7. The drone of claim 6, wherein the firearm malfunction device attachment comprises a malfunction plate, wherein the malfunction plate comprises:
a front wall having a plurality of notches, and
a plurality of magnets detachably connected to the plurality of notches.

8. The drone of claim 6, wherein the firearm malfunction device attachment comprises an inflatable device, wherein the inflatable device comprises:
a first end detachably connected to the front side of the drone housing;
an accelerometer to detect acceleration of the inflatable device;
an airbag having a detonator operationally connected to the accelerometer;
a void space for deployment of the airbag; and
a second end having a magnet to attach the inflatable device to a firearm.

9. A system for interfering with a firearm, the system comprising:
an unmanned drone;
a drone platform;
an air-cooling system, and
a control system.

10. The system of claim 9 wherein the drone platform is hidden from public view.

11. The system of claim 9 wherein the control system comprises a computer which is wirelessly connected to the drone.

12. The system of claim 9 wherein the unmanned drone is operable without user control.

13. The system of claim 9, wherein the drone comprises
a bottom frame;
a plurality of bottom propeller frames detachably connected to the bottom frame;
a plurality of propellers and propeller motors located proximate the bottom of the drone;
a central frame, wherein the central frame is detachably connected to the bottom frame and the plurality propeller motors;
a top frame, wherein the top frame is detachably connected to the central frame;
a drone housing comprising:
a bottom housing, the bottom housing comprising a top face, a bottom face, a plurality of arms, and a perimeter wall;
a top housing, the top housing comprising, a front side, a back side, a bottom end, a top end, and a perimeter wall extending between the top end and bottom end,
wherein the perimeter wall comprises:
a plurality of air frame openings to house the plurality of propellers and propeller motors,
a plurality of air ports positioned over the propeller motors, and
a plurality of air outlets forming channels for air to flow through the drone,
a rear fin extending from the back side of the top housing comprising a top wall and a rear opening to allow access to the drone;
a bottom battery pack system cover extending from the top housing; and
a top battery pack system cover detachably connected to the bottom batter pack system cover.

14. The system of claim 13 wherein the movement of the plurality of propellers provides an air-cooling system comprising the steps of:
drawing ambient air through the rear opening and into the drone;
drawing the ambient air through a plurality of air outlets and toward the plurality of propeller motors;
wherein, the ambient air cools internal drone components as it passes from the rear opening and toward the propeller motors; and
driving the ambient air through the plurality of air frame openings and away from the drone.

15. The system of claim 9 wherein the drone housing is comprised of a hard plastic.

16. A method for interfering with a firearm, the method further comprising:
detecting a target firearm;
launching a drone from a drone platform;
directing the drone in the direction of the target firearm;
contacting the drone with the target firearm;
moving away from the immediate proximity of the target firearm;
detecting the threat of the target firearm; and
returning the drone to the drone platform after determining that the target firearm is malfunctioned or inaccessible.

17. The method of claim 16, wherein after detecting the threat of the target firearm, the method of claim 16 further comprises the steps of:
determining that the target firearm remains operable;
directing the drone in the direction of the target firearm;
contacting the drone with the target firearm; and
moving away from the immediate proximity of the target firearm.

18. The method of claim 16, wherein the step of contacting the drone with the target firearm further comprises the step of applying a firearm malfunction device attachment to the firearm, wherein the firearm malfunction device attached is selected from a group consisting essentially of a bistable band, an inflatable device, a harpoon, a net, a claw, a malfunction plate, and an airbag actuator system.

19. The method of claim 18, wherein the step of applying a firearm malfunction device attachment to the firearm further comprises the steps of:
moving the firearm malfunction device attachment proximate the ejection port of the firearm, wherein the firearm malfunction device attachment is a malfunction plate, the malfunction plate including a plurality of notches with plurality of magnets detachably connected therein;
delivering the plurality of magnets to the ejection port of the firearm when the malfunction plate contacts the firearm; and
withdrawing the malfunction plate from the firearm.

20. The method of claim 18, wherein the step of applying a firearm malfunction device attachment to the firearm further comprises the steps of:
moving the firearm malfunction device attachment proximate the ejection port of the firearm, wherein the firearm malfunction device attachment is an inflatable device, the inflatable device including an accelerometer operatively connected to a detonator attached to an airbag, and a magnet to connect to the firearm;
contacting the magnet of the inflatable device to the firearm;
activating the detonator to expand the airbag;
engulfing the firearm with the airbag, preventing access to the trigger mechanism of the firearm;
detaching the drone from the inflatable device; and
withdrawing the drone from the firearm.
